(19) United States
(12) Patent Application Publication
(10) Pub. No.: US 2025/0197604 A1
(43) Pub. Date: Jun. 19, 2025

(54) HIGH-PERFORMANCE THERMOPLASTIC CELLULOSE ACETATE COMPOSITIONS FORMED WITH ORGANIC PEROXIDE

(71) Applicant: University of Guelph, Guelph (CA)

(72) Inventors: Amar MOHANTY, Guelph (CA); Manjusri MISRA, Guelph (CA); Akhilesh PAL, Guelph (CA); Arturo RODRIGUEZ-URIBE, Guelph (CA); Tao WANG, Guelph (CA); Shiv SHANKAR, Guelph (CA); Shjoadin JAMHA, Guelph (CA); Benjamin ORGAN, Guelph (CA); Ehsan PESARANHAJIABBAS, Guelph (CA)

(73) Assignee: University of Guelph, Guelph (CA)

(21) Appl. No.: 18/545,909

(22) Filed: Dec. 19, 2023

(51) Int. Cl. C08L 1/12; C08J 3/20; C08J 3/22; C08J 5/18; C08K 3/04; C08K 3/26; C08K 3/34; C08K 5/11; C08K 5/14; C08K 13/02; C08L 51/02

(52) U.S. Cl. CPC C08L 1/12; C08J 3/203; C08J 3/226; C08J 5/18; C08K 13/02; C08L 51/02; C08J 2301/12; C08J 2401/02; C08J 2403/02; C08K 3/04; C08K 2003/265; C08K 2003/343; C08K 5/11; C08K 5/14; C08K 2201/014; C08L 2201/06; C08L 2203/30; C08L 2205/025; C08L 2205/03; C08L 2205/08

(57) ABSTRACT

A cellulose acetate composition comprising including at least one cellulose acetate, at least one plasticizer, and at least one organic peroxide. In aspects, the cellulose composition further comprises at least one filler. Also, articles of manufacture comprising the cellulose acetate composition, and method of preparing the cellulose acetate composition comprising (a) mixing at least one cellulose acetate with at least one plasticizer to produce a pre-mixture; and (b) adding at least one additive to the pre-mixture, wherein said at least one additive is an organic peroxide, thereby obtaining the thermoplastic cellulose acetate composition.

### FIELD OF TECHNOLOGY

The present disclosure relates to biodegradable polymers and composites, more particularly to high-performance thermoplastic cellulose acetate compositions.

### BACKGROUND INFORMATION

Cellulose acetates are biobased and broadly biodegradable. However, due to high melting temperatures close to their decomposition temperatures and high melt viscosities, most cellulose acetates can only be melt processed after plasticization. The addition of low-molecular-weight plasticizers presents challenges for achieving a proper balance in processability and properties, especially when high filler contents and specific performance are desired.

### Plasticization

Cellulose acetates are derived from cellulose, the most abundant biopolymer. As acetate esters of cellulose, cellulose acetates can have different degrees of esterification. Cellulose diacetate has two acetyl functional groups on each anhydroglucose unit of the cellulose molecule, while cellulose triacetate has three. Cellulose acetate has high glass transition temperature (T_{g}) and cannot be melt-processed as raw material because it starts to decompose before melting. Therefore, cellulose acetate often needs plasticization to reduce its T_{g} and processing temperature. [1]

Plasticizers increase the flow and thermo-plasticity of a polymer melt by decreasing its viscosity. Cellulose acetates are often plasticized using citrates, phthalates, glycerol derivatives, phosphates, etc. Phthalate plasticizers, which have been the primary plasticizers used in commercial cellulose acetate products, are now under increased scrutiny because of potential harmful effects to the environment and human health. [2]

Recent studies have explored the utilization of low-cost and nontoxic plasticizers. New plasticizers tested include polyethylene glycol [2], polycaprolactone triol [3], and propylene glycol [4]. Some studies also tested maleic anhydride, glycol and triacetin as multi-plasticizers. [5] Quintana et al. [6] plasticized cellulose acetate using triacetin, tripropionin, triethyl citrate, tributyl citrate, tributyl 2-acetyl citrate, and low-molecular-weight polyethylene glycol and compared their mechanical properties, hydrophobicity, and degradation under accelerated weathering using UV-light and water.

WO 2021/150540 A1 (Michael-Sapia et al., 2021) discloses biodegradable cellulose acetate compositions comprising cellulose acetate, plasticizers, and additional component which can be a filler, additive, biodegradable polymer, stabilizer, or odor modifier. [7] The plasticizers include triacetin, triethyl citrate (TEC), and PEG-400. The inorganic filler can be calcium carbonate and other materials. The less than 50% biodegradable polymer can be carbohydrates, cellulosic and organic fillers, polyhydroxyalkanoates, polycaprolactone polymers. The additives include nucleating agents less than 2 μm (magnesium silicate, silicon dioxide, magnesium oxide, or combinations thereof), pigments (titanium dioxide, a carbon black, or an iron oxide), blowing agents (sodium bicarbonate, citric acid, CO2, N2 or an unbranched or branched (C2-6) alkane), mineral and inorganic fillers, food wastes, desiccants, alkaline fillers, or combinations, odor modifying additives, and stabilizers that can include UV absorbers, antioxidants (ascorbic acid, BHT, BHA, etc.), other acid and radical scavengers, epoxidized oils, e.g., epoxidized soybean oil, or combinations. The plasticized cellulose acetate is claimed to be suitable for profile extrusion, sheet extrusion, thermoforming, and injection moulding. The plasticized cellulose acetate films of 0.51 mm thickness show disintegration of at least 90% under industrial composting conditions within 12 weeks.

US Patent 2006/0058425A1 (Mohanty, et al., 2006) describes composites of cellulose esters (cellulose acetate, cellulose acetate butyrate, cellulose acetate propionate, with degrees of substitution of between about 1.20 and 2.95 and degrees of polymerization between about 150 and 300), 10-40% plasticizers (triethylcitrate and bis(2-ethylbenzyl)adipate), maleic anhydride, and layered silicates (1-20%) (smectite clay, onium ion modified clay) with high modulus, strength, dimensional stability, and heat deflection temperature. [8]

### Biodegradability

It has long been recognized that cellulose acetates can be biodegradable and the degradation rate is dependent on the degree of substitution. [9,10] The degradation of cellulose acetates can be accelerated by using additives such as titanium dioxide. [11] Phuong et al. [1] studied the biodegradability of cellulose acetate plasticized with triacetin and diacetin, and found that the test samples with 30% triacetin or triacetin-diacetin were completely degraded within 46 days of composting. Yadav and Hakkarainen [12] summarized the factors affecting cellulose acetate degradation as well as the biological (enzyme and microorganism), chemical, and physical methods of cellulose acetate degradation.

European Patent Application 0 597 478A1 (Itoh, et al., 1993) discloses biodegradable cellulose ester compositions comprising cellulose acetate with low degrees of substitution, from 1.0 to 2.15. The compositions may contain a plasticizer, a photolysis accelerator, and a biodegradation accelerator such as organic acids. [13]

U.S. Pat. Appl. Publ. No. 2012/0325233 (Wilson, et al., 2012) discloses cellulose esters incorporating mixed-phase titanium dioxide particles. Plasticized cellulose esters can be made into fibers, yarn, filter, or other moulded articles. The titanium dioxide particles can help improve the environmental degradability. [14]

U.S. Pat. Appl. Publ. No. 2021/0363331 A1 (Ga and Suzuki, 2021) discloses cellulose acetate compositions with good biodegradability, water solubility, and thermoformability. [15] The cellulose acetate can have a degree of substitution of 0.4 to 1.4. The cellulose acetate is plasticized with citrate ester-based plasticizers and made into moulded articles including fibers, films and hollow cylindrical shape. The films can be prepared by solvent casting using water or acetone and water (9:1) and compression moulding. The biodegradability was evaluated by using activated sludge in accordance with JIS K6950. For the thermo-formability evaluation, the films were prepared by solvent casting, cut into 0.3 cm×1 cm pieces, and then pressed at 150, 175, and 200° C. The test pieces were not melted, but fused.

U.S. Pat. No. 5,219,510 (Machell and Sand, 1993) describes a method for manufacturing cellulose acetate films through melt extrusion casting as an alternative to the traditional solvent casting process. [16] The disclosure of U.S. Pat. No. 5,219,510 achieves melt compounding of the cellulose acetate by using a low-volatility phosphoric acid ester as a plasticizer. Phosphate esters such as triphenyl phosphate provide plasticization, but their volatility is problematic. This disclosure plasticizes cellulose acetate using arylene bis(diaryl phosphate) esters or compounds with similar structures, which are claimed to be non-volatile under the melt processing conditions.

### Blends and Composites

An important strategy to reach the desired properties and biodegradability of cellulose acetate compositions is to blend it with other polymers. Examples include starch [17], poly(s-caprolactone) [18], poly(L-lactide) and other aliphatic polyesters. [19] Wu evaluated the composite materials composed of maleic anhydride-grafted poly(butylene adipate-co-terephthalate) (PBAT-g-MA) and cellulose acetate. [20] It was found that both the PBAT and the PBAT-g-MA/cellulose acetate composite films were eventually completely degraded, and severe disruption of film structure was observed after 60-100 days of incubation. The degree of weight loss after burial indicated that both materials were biodegradable.

Another strategy is the addition of fillers. For example, composites were prepared by the addition of wool fibre waste [21], poly(ethylene glycol) [22], graphene oxide [23], exfoliated graphene [24], various nanoclays [25, 26], silver nanoparticles [27], titanium dioxide [28] with improved mechanical, barrier, and antimicrobial properties depending on the type of fillers used.

Japanese Patent Application JP2001200084A (Nakanishi, 2000) discloses foamable cellulose acetate resin containing biodegradable fillers including corn starch, rice flour, starch, wood flour, straw, rice husk, okara, fu (wheat gluten used in Japanese cuisine), chitin and chitosan and a modifier such as polyethylene, polypropylene, and an ethylene/vinyl acetate copolymer. [29] The biobased materials enhance the biodegradability. The modifier maintains the biodegrability while enhancing the mechanical properties, processability and dimensional stability. The foam can be used for a heat insulation, cushioning, packaging and alike.

U.S. Pat. Appl. Publ. No. U.S. Pat. No. 5,292,783 (Buchanan, et al., 1994) discloses binary blends of cellulose esters with aliphatic polyesters or aliphatic-aromatic copolyesters and ternary blends of the three types of polymers. [30] Blend miscibility is affected by the molecular weight of the polyesters. The blend properties can be adjusted by varying the blend compositions. The blends can have high strength, modulus, and heat deflection temperature. The water vapor barrier can be improved with the hydrophobic additives. Monitoring of weight loss of test films showed partial degradation in wastewater and compost when the degree of substitution is higher than 1.7.

U.S. Pat. No. 5,599,858 (Buchanan, et al., 1997) describes similar binary and ternary blends containing 5-98% cellulose esters (DS 1.7-3.0). [31] The aliphatic-aromatic copolyester can be prepared from dicarboxylic acids or derivatives (malonic, succinic, glutaric, adipic, pimelic, azelaic, sebacic, fumaric, 2,2-dimethyl glutaric, suberic, 1,3-cyclopentanedicarboxylic, 1,4-cyclohexanedicarboxylic, 1,3-cyclohexanedicarboxylic, diglycolic, itaconic, maleic, 2,5-norbornanedicarboxylic, 1,4-terephthalic, 1,3-terephthalic, 2,6-naphthalene dicarboxylic, 1,5-naphthalene dicarboxylic) and diols (ethylene glycol, diethylene glycol, propylene glycol, 1,3-propanediol, 2,2-dimethyl-1,3propanediol, 1,3-butanediol, 1,4-butanediol, 1,5-pentanediol, 1,6-hexanediol, 2,2,4-trimethyl-1,6-hexanediol, thiodiethanol, 1,3-cyclohexanedimethanol, 1,4-cyclohexanedimethanol, 2,2,4,4-tetramethyl-1,3-cyclobutanediol, triethylene glycol, tetraethylene glycol, di-, tri-, tetrapropylene glycol). The aliphatic-aromatic polyester is selected from the groups consisting of poly(ethylene glutarate-co-terephthalate), poly(tetramethylene glutarate-co-terephthalate), poly(tetramethylene adipate-co-terephthalate), poly(ethylene adipate-co-terephthalate), poly(tetramethylene succinate-co-terephthalate), or poly(ethylene succinate-co-terephthalate), and the mole % of terephthalate is 15-55%. The blend contains at least one additional additive (0.001-50 wt %) selected from a non-polymeric plasticizer, a thermal stabilizer, an antioxidant, a pro-oxidant, an acid scavenger, an ultraviolet light stabilizer, a promoter of photodegradation, inorganics, and colorants. The blends were used to prepare films or fibers.

European Pat. No. EP 2 500 378 B1 (Law, 2012) and U.S. Pat. No. 9,062,186 B2 (Longdon, 2015) describe blends of cellulose acetate and biodegradable polymers such as polybutylene succinate, polybutylene succinate adipate, and polybutylene adipate terephthalate. [32, 33] In typical applications, the content of cellulose acetate is 41-73%, with its weight ratio to the secondary polymer being 10:1 to 30:1. The compositions also contain plasticizers such as triacetin, fillers such as calcium carbonate, talc, and TiO₂, and lubricants. The compositions may be compostable according to EN13432 and ASTM D6400.

Cellulose acetates have great potential to meet the market's demand for products that are made from renewable resources and are biodegradable. However, challenges remain. Cellulose acetates with low degree of substitution lack the thermo-plasticity to be melt processable for practical uses. Cellulose acetates with high degree of substitution are easier to be plasticized but tend to lose the advantage of biodegradability. Plasticizers increase the flow and flexibility of a polymer by reducing the viscosity of the polymer melt and often the glass transition and melting temperatures. High contents of plasticizers, however, cause the mechanical and barrier properties to decrease. Blends and composites can enhance the processability and properties, but miscibility and compatibility are often issues. In particular, high filler contents often lead to reduced melt viscosities, making processing difficult or not feasible. In the case of food packaging, high barrier properties are needed for keeping the food safe and fresh, which are not attainable with high plasticizer contents.

Organic peroxides have been used as additives in polymer blends for purposes differing from that of the present disclosure. For example, it has been reported that the addition of triethyl citrate and dicumyl peroxide enhances the phase compatibility of poly(hydroxybutyrate-co-hydroxyvalerate) (PHBV) and poly(s-caprolactone) (PCL) blends. [34] Among the most popular bioplastics, poly(L-lactic acid) (PLLA) and poly(butylene succinate) (PBS) have complementary properties. PLLA has high modulus and strength but is brittle and has slow crystallization rate. PBS is ductile, but low in stiffness. Organic peroxides have been found to enhance the miscibility of PLLA/PBS blends, leading to improved rheological and mechanical properties thanks to better dispersion and interfacial adhesion. The organic peroxides that have been tested include dicumyl peroxide, benzoyl peroxide, di(tert-butylperoxyisopropyl) benzene, and 2,5-bis(tert-butylperoxy)-2,5-dimethylhexane (Luperox© 101), which are all required in concentrations below 1 wt %. [35] U.S. Pat. No. 11,279,823 B2 (Mohanty, et al., 2022) discloses the use of free radical initiators including various organic peroxides to obtain nano-blends of biopolymers such as PLA, PBAT, PBS, and PBSA. [36] The nano-blends show balanced stiffness, toughness, and thermal and dimensional stabilities. U.S. Pat. No. 11,279,823 B2 and a previous study [37] demonstrate a dramatic increase of the melt viscosity of biopolymer blends (decrease of melt flow) with the addition of the organic peroxide.

In prior art, organic peroxides are used as radical initiators to enable polymerization and chain grafting or to enhance the miscibility of polymer blends. Because of their tendency to enhance cross-linking, the melt flow tends to decrease with the addition of the peroxide. In the case of cellulose acetates, the common challenge is how to improve the flow to enable melt processing and moulding. Therefore, one of ordinary skill in the art would not use organic peroxide to improve the processability of cellulose acetates.

### SUMMARY OF DISCLOSURE

The present disclosure overcomes the technical challenges of prior art by using organic peroxides or acid anhydrides as additives in cellulose acetate compositions.

In one embodiment, the present disclosure provides for a cellulose acetate composition comprising at least one cellulose acetate, at least one plasticizer, and at least one additive, wherein the additive is an organic peroxide.

In one embodiment of the cellulose acetate composition of the present disclosure, the acetate composition further comprises at least one filler, wherein the at least one filler is in the amount up to 40 wt %, and wherein the at least one filler includes biocarbon derived from biomass or waste resources, a mineral filler, and an organic filler, and wherein: the mineral filler includes one or more of talc, calcium carbonate, wollastonite, calcium sulfate, mica, magnesium oxysulfate, silica, and kaolin, and the organic filler includes one or more of starch, cellulose, and microcrystalline cellulose.

In another embodiment of the cellulose acetate composition of the present disclosure, the composition is characterized by having a melt flow index greater than 6 (g/10 min) (210° C., 2.16 kg).

In another embodiment of the cellulose acetate composition of the present disclosure, the plasticizer is biodegradable.

In another embodiment of the cellulose acetate composition of the present disclosure, the composition further comprises an anhydride-grafted cellulose acetate compatibilizer.

In another embodiment of the cellulose acetate composition of the present disclosure, the composition has a heat deflection temperature greater than 85° C.

In another embodiment of the cellulose acetate composition of the present disclosure, moulded sheets of the composition with a thickness of up to 0.4 mm reach a degree of disintegration of at least 90% within twelve weeks (84 days) under thermophilic aerobic composting conditions.

In another embodiment of the cellulose acetate composition of the present disclosure, a powder form of the cellulose acetate composition of the present disclosure reaches at least 90% biodegradation within one year in sandy marine environment.

In another embodiment, the present disclosure relates to an article of manufacture comprising a cellulose acetate composition according to any one of the cellulose acetate compositions of the present disclosure.

In one embodiment of the article of manufacture of the present disclosure, the article is a melt-processed article. In another embodiment of the article of manufacture of the present disclosure, the article is a moulded article.

In another embodiment, the present disclosure relates to a method for preparing the cellulose acetate composition according to any one of the embodiments of the present disclosure. In one embodiment, the method comprises: (a) mixing at least one cellulose acetate with at least one plasticizer to produce a pre-mixture; and (b) adding at least one additive to the pre-mixture, wherein said at least one additive is an organic peroxide, thereby obtaining the thermoplastic cellulose acetate composition.

In one embodiment of the method for preparing the cellulose acetate composition of the present disclosure, the at least one additive is present in the amount from 0.03 to 1 phr.

In another embodiment of the method for preparing the cellulose acetate composition of the present disclosure, the at least one additive is an organic peroxide, and wherein the organic peroxide is mixed with at least one filler prior to being added to the pre-mixture of cellulose acetate and plasticizer, wherein the at least one filler facilitates the dispersion of the organic peroxide, and the organic peroxide facilitates the adhesion between the at least one filler and cellulose acetate, and wherein the at least one filler includes biocarbon derived from biomass or waste resources, a mineral filler, an organic filler, or a combination thereof.

In another embodiment of the method for preparing the cellulose acetate composition of the present disclosure, the cellulose acetate has a degree of substitution from 1.2 to 2.9.

In another embodiment of the method for preparing the cellulose acetate composition of the present disclosure, the plasticizer is present in an amount from 5 to 50% with respect to the weight of cellulose acetate and plasticizer.

In another embodiment of the method for preparing the cellulose acetate composition of the present disclosure, the organic peroxide is combined with a hybrid of different types of plasticizers to adjust the melt flow and mechanical properties of the thermoplastic cellulose acetate composition. In one aspect, the hybrid of different plasticizers includes one or more biodegradable plasticizers.

In another embodiment of the method for preparing the cellulose acetate composition of the present disclosure, the method further comprises the step of adding an anhydride-grafted cellulose acetate to the thermoplastic cellulose acetate composition.

In another embodiment, the present disclosure provides for a method of increasing the melt flow index of a cellulose acetate composition. In one embodiment, the method comprises adding an additive to a mixture of cellulose acetate and a plasticizer, wherein the additive is an organic peroxide.

In another embodiment of the method of increasing the melt flow index of a cellulose acetate composition of the present disclosure, the method further comprises mixing the additive with at least one filler prior to adding the additive to the mixture of cellulose acetate and plasticizer, wherein the at least one filler includes biocarbon derived from biomass or waste resources, a mineral filler, an organic filler, or a combination thereof.

In another embodiment, the present disclosure provides for a method of preparing an anhydride-grafted cellulose acetate compatibilizer by single-step reactive extrusion.

In one embodiment the method comprises mixing at least one cellulose acetate, at least one plasticizer, at least one additive, and at least one filler, wherein the at least one plasticizer is present in the amount from 10 to 50 wt %, wherein the at least one additive is an organic peroxide, an acid anhydride, or a combination of the organic peroxide and the acid anhydride, and wherein the at least one filler includes biocarbon derived from biomass or waste resources, a mineral filler, an organic filler, or a combination thereof.

In one embodiment of the method of preparing an anhydride-grafted cellulose acetate compatibilizer by single-step reactive extrusion of the present disclosure, the organic peroxide is from 0.03 to 1 phr.

### BRIEF DESCRIPTION OF THE DRAWINGS

The following figures illustrate various aspects and preferred and alternative embodiments.

FIG. 1. Scanning electron microscopy of the fracture surfaces shows the effect of the organic peroxide addition (0.075 phr and 0.5 phr) on the microstructure of cellulose acetate compositions.

FIG. 2. Photographs of injection moulded cutlery made from the cellulose acetate compositions of the present disclosure.

FIGS. 3A-3E. Photographs of (3A) Injection moulding of a cellulose acetate composition into Nespresso® compatible coffee capsules; (3B) Injection moulded Nespresso® compatible coffee capsule of Example 27; (3C) Bottom of a coffee capsule manufactured with an embodiment of a cellulose acetate composition of the present disclosure after being punctured by the needles of an electric coffeemaker, showing satisfactory performance; (3D) Injection moulded Nespresso® compatible coffee capsule of Example 28. (3E) Injection moulded K-cup® compatible coffee capsule of Example 29.

FIG. 4. Photograph of a Nespresso® compatible coffee capsule made from the cellulose acetate composition of the present disclosure by thermoforming.

### DETAILED DISCLOSURE

### Definitions

In this specification and in the claims that follow, reference will be made to several terms that shall be defined to have the meanings below. All numerical designations, e.g., dimensions and weight, including ranges, are approximations that typically may be varied (+) or (−) by increments of 0.1, 1.0, or 10.0, as appropriate. All numerical designations may be understood as preceded by the term “about”.

The term “about” modifying any amount refers to the variation in that amount encountered in real-world conditions of producing materials such as polymers or composite materials, e.g., in the lab, pilot plant, or production facility. For example, an ingredient employed in a mixture when modified by “about” includes the variation and degree of care typically employed in measuring chemicals and materials in a plant or lab. For example, the amount of a product component when modified by “about” includes the variation between batches in a plant or lab and the variation inherent in the analytical method. Whether or not modified by “about”, the amounts include equivalents to those amounts. Any quantity stated herein and modified by “about” can also be employed in the present invention as the amount not modified by “about”.

The term “comprising” means any recited elements are necessarily included and other elements may optionally be included. “Consisting essentially of” means any recited elements are necessarily included, elements that would materially affect the basic and novel characteristics of the listed elements are excluded, and other elements may optionally be included. “Consisting of” means that all elements other than those listed are excluded. Embodiments defined by each of these terms are within the scope of this invention.

The term “DS” refers to the degree of substitution, which is the average number of hydroxyl groups (—OH) that have been substituted with acetyl groups in each anhydroglucose unit.

The term “biodegradable” refers to a material being prone to be broken down by the biological action of naturally occurring microorganisms such as fungi and bacteria. The term “universally biodegradable” refers to a material being biodegradable in various environments (e.g., compost and sea water).

The term “compostable” refers to a material being prone to be broken down into water, carbon dioxide, and biomass by microorganisms in a compost, which can be a decomposing mass of plant, manure, and other organic waste. The term “compostable” can include “industrially compostable” and “home compostable”. The term “industrially compostable” means that the material satisfies the requirements set forth by ASTM D6400 Standard Specification for Labeling of Plastics Designed to be Aerobically Composted in Municipal or Industrial Facilities. The term “home compostable” refers to a material satisfying the requirements set forth by the standards NF T 51-800—Specifications for Plastics Suitable for Home Composting or AS 5810—Biodegradable Plastics Suitable for Home Composting.

The term “hybrid fillers” refers to the combination of two or more fillers that can be organic or inorganic and be either physically or chemically different.

The term “wt. %” refers to the weight percent of a component with respect to the weight of the whole composition, which can include one or more of a polymer, a polymer blend, a plasticized polymer, a plasticized polymer blend, a compatibilizer, and a filler.

The term “%” refers to “wt. %” unless specified otherwise.

The term “phr” is parts per hundred resin. It denotes the mass proportion of an additive with respect to one hundred parts of the whole composition.

The term “HDT” is “heat deflection temperature” or “heat distortion temperature”, which are used interchangeably. It refers to the temperature at which a polymer object deforms under a specified load. The HDT is determined by the following test procedure outlined in ASTM D648. The test specimen is loaded in three-point bending mode in the edgewise direction. The two most common loads are 0.455 MPa or 1.82 MPa and the temperature is increased at 2° C./min until the specimen deflects 0.25 mm.

The term “barrier” refers to the property of blocking or impeding the permeation of water vapor or gas molecules. It is evaluated by measuring the transmission rate at specified conditions of temperature, relative humidity, and pressure.

### Overview

The present disclosure relates to thermoplastic cellulose acetate compositions and articles formed with organic peroxides and methods for the preparation thereof. In embodiment, the thermoplastic cellulose acetate compositions of the present disclosure are highly-filled, high-performance thermoplastic cellulose acetate compositions.

The inventors have unexpectedly discovered that organic peroxides, when used together with at least one plasticizer, provides a synergistic effect that improves the processability of cellulose acetates. This enables the preparation of highly-filled and high-performance compositions provided in this disclosure.

The addition of organic peroxide enhances the melt flow of cellulose acetate compositions, thereby enabling the incorporation of high filler contents and achieving high performances such as superior barrier.

### Cellulose Acetate Compositions

In one embodiment, the present disclosure relates to the use of organic peroxide to prepare thermoplastic cellulose acetate compositions. In embodiments, the compositions of the present disclosure comprise at least one cellulose acetate, at least one plasticizer (including biodegradable plasticizers), and at least one additive (including but not limited to organic peroxide and acid anhydride or a combination of organic peroxide and acid anhydride).

### Method to Produce Thermoplastic Cellulose Acetate Compositions

In one embodiment, a method to produce a thermoplastic cellulose acetate composition comprises the following steps:
(i) mixing cellulose acetate with a plasticizer to produce a pre-mixture, and
(ii) adding an organic peroxide to the pre-mixture of cellulose acetate and plasticizer to produce a mixture.

In one embodiment of the method to prepare thermoplastic cellulose acetate compositions, the method also includes (iii) process the mixture of (ii) at a suitable temperature.

In aspects of the method to prepare thermoplastic cellulose acetate compositions, the cellulose acetate that is mixed with the plasticizer is dried cellulose acetate powder.

In aspects of the method to prepare thermoplastic cellulose acetate compositions, the first pre-mixture is conditioned under ambient or room temperature.

In aspects of the method to prepare thermoplastic cellulose acetate compositions, the organic peroxide is mixed with a solvent prior to being added to the pre-mixture to aid dispersion.

In aspects of the method to prepare thermoplastic cellulose acetate compositions, the suitable temperature of step (iii) is between 120° C. and 240° C.

Cellulose Acetate Compositions with Fillers

In another embodiment of the cellulose acetate compositions of the present disclosure, the cellulose acetate composition includes at least one organic peroxide additive and at least one type or different types of fillers.

In one embodiment, a composition of the present disclosure comprises at least one cellulose acetate, at least one plasticizer (including biodegradable plasticizers), at least one organic peroxide and at least one filler (including organic and inorganic fillers).

Method to Produce Thermoplastic Cellulose Acetate Compositions with Fillers

In embodiments of the cellulose acetate compositions of the present disclosure, the organic peroxide is mixed with the at least one filler prior to being mixed with the pre-mixture of cellulose acetate and plasticizers. A synergistic effect is achieved. The organic peroxide improves melt flow properties, facilitating the incorporation of the fillers. The high surface area of the fillers, and in some embodiments, the porosity of the fillers, facilitate the dispersion of the organic peroxide in the compositions.

In one embodiment, a method to produce the cellulose acetate compositions of the present disclosure comprises the following steps:
(i) mixing cellulose acetate with a plasticizer to produce a first pre-mixture, and
(ii) mixing organic peroxide with at least one filler (including organic and inorganic fillers) to produce a second pre-mixture, and
(iii) adding the second pre-mixture to the first pre-mixture of cellulose acetate and plasticizer.

In one embodiment of the method to produce the cellulose acetate compositions of the present disclosure, the method also comprises (iv) processing the material of step (iii) at a suitable temperature, such as a temperature between 12° and 240° C.

In aspects of the method to produce the cellulose acetate compositions of the present disclosure, the cellulose acetate that is mixed with the plasticizer is dried cellulose acetate powder.

In aspects of the method to produce the cellulose acetate compositions of the present disclosure, the first pre-mixture is conditioned under ambient or room temperature.

In aspect of the method to produce the cellulose acetate compositions of the present disclosure, the organic peroxide is mixed with a solvent prior to being mixed with the at least one filler to aid dispersion.

### Organic Peroxides

A broad range of organic peroxides can be used in the methods and compositions of the present disclosure. Non-limiting examples of the organic peroxides include dicumyl peroxide, benzoyl peroxide, dibenzoyl peroxide, 2,5-dimethyl-2,5-di(tert-butylperoxy)-hexane, tert-butylperoxy-3,5,5-trimethyl hexanoate, tert-butyl peroxybenzoate, tert-butylperoxy 2 ethylhexyl carbonate, 2,5-bis(tert-butylperoxy)-2,5-dimethylhexane, 2,5-dimethyl-2,5-di(tert-butylperoxy) hexane, 2,5-dimethyl-2,5-di(t-amylperoxy) hexane, 4-(tert-butylperoxy)-4-methyl-2-pentanol, 1,3-bis(tert-butylperoxyisopropyl)benzene, 3,6,9-Trirthyl-3,6,9-Trimethyl-1,4,7-Triperoxonane, ethyl 3,3-bis(t-butylperoxy) butyrate, ethyl 3,3-bis(t-amylperoxy) butyrate, tert-butylperoxy-3,5,5-trimethylhexanoate, or similar compounds.

In embodiments, the compositions of the present disclosure lowers the glass transition temperature of the cellulose acetate compositions without the additive. In some embodiments, the addition of less than 0.1 phr organic peroxide lowers the glass transition temperature of cellulose acetate compositions by 3% or more than 3%. In some embodiments, the addition of organic peroxide lowers the glass transition temperature of cellulose acetate compositions by 4% or more than 4%. In some embodiments, the addition of organic peroxide lowers the glass transition temperature of cellulose acetate compositions by 5% or more than 5%.

### Cellulose Acetate

The method of the present disclosure can be used with a plurality of cellulose acetates varying in degrees of substitution. Cellulose acetates are acetate esters of cellulose. The repeating anhydroglucose unit of cellulose chains has three hydroxyl groups which can react to form acetate esters. The degree of substitution is the average number of hydroxyl groups being substituted with acetyl groups on each anhydroglucose unit.

In embodiments of the present disclosure, cellulose acetates of different degrees of substitution are combined in different weight ratios to provide the desired melt flow behavior, mechanical properties, and biodegradation targets.

In embodiments of the present disclosure, the cellulose acetate are acetate products with degrees of esterification commonly found in the market and are biodegradable.

In embodiments of the present disclosure, the method of producing the cellulose acetate composition of the present disclosure can be used with cellulose acetates of low degrees of substitution to achieve the processability required. Cellulose acetates with low degrees of substitution that can be used in the methods and compositions of the present disclosure include, for example, those with DS of 1.4, 1.5. 1.6, 1.7, 1.8, 1.9, 2.0, 2.1, 2.2, 2.3, or 2.4.

### Fillers

In embodiments of the present disclosure, the addition of the organic peroxide additive improves the interaction between the at least one filler and the polymer matrix of cellulose acetate. This leads to stronger adhesion and in turn improved properties of the compositions compared to the compositions without the additive.

The method of producing the cellulose acetate compositions of the present disclosure enables up to 40 wt % incorporation of filler contents.

As illustrated in the Examples below, compositions containing 31 wt % fillers with respect to the total weight of the compositions show melt flow index (MFI) values of greater than 30 (g/10 min) (210° C., 2.16 kg). In embodiments, the compositions containing 31 wt % fillers with respect to the total weight of the compositions show MFI values of between 11 and 20 (g/10 min) (210° C., 2.16 kg). In embodiments, the compositions containing 31 wt % fillers with respect to the total weight of the compositions show MFI values of between 5 to 10 (g/10 min) (210° C., 2.16 kg).

In embodiments, the at least one filler of the compositions of the present disclosure can be chosen from talc, calcium carbonate, wollastonite, graphite, other mineral fillers or any combinations thereof. In embodiments, the at least one filler includes hybrids of different mineral fillers.

In embodiments, the at least one filler can be chosen from starch, cellulose, protein, other organic fillers or any combinations thereof. In some embodiments, the at least one filler includes hybrids of different organic fillers.

In embodiments, the at least one filler can be a hybrid of mineral and organic fillers.

In embodiments, the at least one filler can be biocarbon obtained from the pyrolysis of biomass. “Pyrolysis” may be defined as the chemical and thermal decomposition of organic materials at a temperature of 400° C. or greater than 400° C. in the absence of oxygen.

In embodiments, the at least one filler can be a hybrid of biocarbon and other fillers (organic and/or inorganic fillers).

### Plasticizers

In a further aspect, the cellulose acetate compositions of the present disclosure include the cellulose acetate and organic peroxide in combination with different plasticizers to achieve different plasticizing effect. Examples of plasticizers include triacetin, triethyl citrate, acetyl triethyl citrate, acetyl tributyl citrate, and polyethylene glycol. Triacetin is a triester of glycerol and acetic acid. Triethyl citrate is an ester of citric acid. Acetyl tributyl citrate is obtained by the acetylation of tributyl citrate. The melt flow behavior of the cellulose acetate compositions of the present disclosure will also be dependent on the plasticizer used.

In some embodiments, the cellulose acetate compositions of the present disclosure include organic peroxide and hybrid plasticizers. The resultant compositions can demonstrate melt flow and other properties between the compositions plasticized with the plasticizers used at the same amount individually.

In some embodiments, the plasticizer can be biobased and biodegradable. An example of biobased plasticizer is biobased triacetin.

### Anhydride-Grafted Cellulose Acetate

In another aspect, the present disclosure provides a method for synthesizing anhydride-grafted cellulose acetate compositions in a single reactive extrusion step. In one embodiment, cellulose acetate is mixed with a plasticizer to produce a pre-mixture. Maleic anhydride powder is then mixed into the pre-mixture to form a mixture. Organic peroxide is then added to the mixture to form a material. The material may then be melt processed at a temperature between 12° and 240° C.

In embodiments for the preparation of anhydride-grafted cellulose acetate, the cellulose acetate is provided as a dried powder.

In embodiments for the preparation of anhydride-grafted cellulose acetate, the mixing of the cellulose acetate with the plasticizer is done at an appropriate weight ratio and conditioned at room temperature.

In embodiments for the preparation of anhydride-grafted cellulose acetate, the organic peroxide is provided in a solvent.

In embodiments for the preparation of anhydride-grafted cellulose acetate, the organic peroxide is added to the mixture and agitated for 5 to 15 minutes to form the material.

During the preparation of anhydride-grafted cellulose acetate, the organic peroxide can be first mixed with a filler or combination of fillers (i.e. with at least one filler) before being added to the pre-mixture of cellulose acetate and plasticizer. In a typical example, the cellulose acetate is mixed with a plasticizer to form the pre-mixture and maleic anhydride powder is added to the pre-mixture. In one embodiment, organic peroxide, which may be provided in a solvent, is mixed with the filler or combination of fillers before being added to the pre-mixture of cellulose acetate and plasticizer and agitated for 5 to 15 min to form the material. The material may then be processed at a temperature between 12° and 240° C.

In another aspect, the anhydride-grafted cellulose acetate composition of the present disclosure may be used as a compatibilizer in cellulose acetate compositions with one or more fillers. The poor flow of cellulose acetate is a challenge for preparing cellulose acetate compatibilizers. Cellulose acetate mixed with plasticizer alone is difficult to process. In embodiments, the methods of the present disclosure enable the preparation of anhydride-grafted compatibilizers.

In embodiments, the anhydride-grafted cellulose acetate compatibilizer of the present disclosure improves the Heat Deflection Temperature (HDT) of cellulose acetate compositions. Higher HDT is often desired for materials making articles for food service.

In embodiments, the anhydride-grafted cellulose acetate compatibilizer of the present disclosure improves the mechanical properties such as the modulus of cellulose acetate compositions.

### Properties and Articles of Manufacture

In another aspect, the cellulose acetate compositions of the present disclosure are biodegradable, including in industrial composting facilities, home compost, and marine environment. The term “compostable” can include “industrially compostable” and “home compostable”. The term “industrially compostable” means that the material satisfies the requirements set by ASTM D6400 Standard Specification for Labeling of Plastics Designed to be Aerobically Composted in Municipal or Industrial Facilities. The term “home compostable” refers to a material satisfying the requirements set by the standards NF T 51-800—Specifications for Plastics Suitable for Home Composting or AS 5810—Biodegradable Plastics Suitable for Home Composting.

In embodiments, sheets of 0.4 mm in thickness produced with the cellulose acetate compositions of the present disclosure show greater than 90% disintegration after 90 days when tested according to ISO 20200—Plastics—Determination of the Degree of Disintegration of Plastic Materials under Simulated Composting Conditions in a Laboratory-Scale Test. In embodiments, films of cellulose acetate compositions of the present disclosure having 0.12 mm in thickness show greater than 99% disintegration after 90 days when tested according to ISO 20200.

In embodiments, the powders of the cellulose acetate compositions of the present disclosure show greater than 80% degradation in a simulated marine environment when tested according to ASTM D7991—Standard Test Method for Determining Aerobic Biodegradation of Plastics Buried in Sandy Marine Sediment under Controlled Laboratory Conditions. The percentage of biodegradation is evaluated as the percentage of the evolved CO2 with respect to the theoretical CO2. In some embodiments, the powders of the cellulose acetate compositions of the present disclosure show greater than 90% degradation in a simulated marine environment in accordance with ASTM D7991. In embodiments, the powders of the cellulose acetate compositions of the present disclosure show greater than 95% degradation in a simulated marine environment in accordance with ASTM D7991.

In embodiments, the cellulose acetate compositions of the present disclosure can be moulded into shaped articles. The appropriate melt flow properties of the compositions allow fast and smooth moulding operations and the manufacturing of defect-free products.

In embodiments, the cellulose acetate compositions of the present disclosure are formed into articles for disposable food service. Examples include cutlery, food trays, and stirring sticks.

In embodiments, the cellulose acetate compositions of the present disclosure are formed into rigid packaging. Examples include various types of single-serve coffee containers.

In embodiments, the cellulose acetate compositions of the present disclosure have an oxygen transmission rate of 0.02 cc/pkg-day or less, or an oxygen transmission rate of 0.01 cc/pkg-day or less, or an oxygen transmission rate of 0.003 cc/pkg-day or less, wherein the oxygen transmission rate is measured at 0% relative humidity (RH) and 23° C. and converted to a normalized thickness of 600 micrometers (23.6 mils).

In embodiments, the cellulose acetate compositions of the present disclosure have water vapor transmission rate of 0.38 g/pkg-day or less, or a water permeation rate of 0.08 g/pkg-day or less, or a water permeation rate of 0.06 g/pkg-day or less, wherein the water permeation rate is measured at 100% RH and 37.8° C. and converted to a normalized thickness of 600 micrometers (23.6 mils).

The non-limiting examples below are provided to aid the understanding of the invention. They help illustrate the embodiments of the disclosure but do not limit the scope of the disclosure. Other aspects, applications, advantages, and modifications within the scope of the disclosure will be apparent to those of ordinary skill in the art.

The Examples are part of the description.

### EXAMPLES

### Materials

The information on the materials used in the examples are summarized in Table 1. The polymer matrix of the compositions is cellulose acetate of different degrees of substitution (DS). Various types of plasticizers and organic peroxides are used. The filler system comprises various mineral fillers including but not limited to talc, calcium carbonate, and graphite, various organic materials including but not limited to starch, cellulose, and protein, biocarbon, and combinations thereof. The size of the talc used is on the level of 1˜10 μm. The size of the calcium carbonate used is also on the level of 1˜10 μm.

In addition, biocarbon is a carbon-rich material prepared by pyrolyzing biomass at elevated temperatures followed by milling with specific conditions given in relevant examples.

### Table 1. Materials Used in all Examples

TABLE 1
Materials used in all examples

| | Details of the materials | | |
|---|---|---|---|
| | | Grade or Trade | |
| | Name | name | Supplier |
| Cellulose | Cellulose acetate | CA-398-30 | Eastman ™ |
| esters | (DS: 2.5) | | Chemical |
| | | | Company, USA |
| | Cellulose acetate | RTW | Sichuan Push |
| | (DS: 2.25) | | Acetati Co., Ltd., |
| | | | China |
| Plasticizers | Triacetin | 525073-20L | Sigma Aldrich ™, |
| | | | Canada |
| | Triacetin | AC139220100 | Thermo Fisher |
| | | | ScientificTM Inc., |
| | | | USA |
| | Triacetin | Petroleum-based | Wuhan Golden |
| | | food-grade | Wing Industry & |
| | | | Trade Co., Ltd., |
| | | | China |
| | Biobased triacetin | Biobased triacetin | Wuhan Golden |
| | | | Wing Industry & |
| | | | Trade Co., Ltd., |
| | | | China |
| | Triethyl citrate | 109290 | Sigma Aldrich ™, |
| | | | Canada |
| Additives | 2,5-dimethyl-2,5- | Luperox ® 101 | Arkema ™ S.A., |
| | di(tert-butylperoxy)- | | France |
| | hexane | | |
| | 3,6,9-Triethyl-3,6,9- | Trigonox ® 301 | Sigma Aldrich ™, |
| | trimethyl-1,4,7- | | Canada |
| | triperoxonane | | |
| | Bis(1-methyl-1- | Dicumyl peroxide | Thermo Fisher |
| | phenylethyl) peroxide | | Scientific ™ Inc., |
| | | | USA |
| | tert-Butyl peroxy- | Trigonox ® 42S | United Initiators |
| | 3,5,5- | | Inc., USA |
| | trimethylhexanoate | | |
| | Maleic anhydride | AC125240050 | Thermo Fisher |
| | | | Scientific ™ Inc., |
| | | | USA |
| | Alkyl ketene dimer | AKD-1840 | Hefei TNJ |
| | (AKD) | | Chemical Industry |
| | | | Co., Ltd., China |
| Mineral | Talc [size: ~1.5 μm] | Jetfine ® 3CC | Imerys ™, US |
| fillers | Talc [size: ~1.5 μm] | TAL-10000 | Guangdong |
| | | | Qiangda New |
| | | | Materials |
| | | | Technology Co., |
| | | | Ltd, China |
| | Calcium Carbonate | CAZ-2380 | Guangdong |
| | [size: ~10 μm] | | Qiangda New |
| | | | Materials |
| | | | Technology Co., |
| | | | Ltd, China |
| | Graphite | GrapheneBlack ™ | Nano Xplore ™ |
| | [size: ~3 μm] | 3X | Inc., Canada |
| Organic | Starch | Hylon ® VII | Ingredion ™ Inc., |
| fillers | | | USA |
| | Microcrystalline | Comprecel ™ | Mingtai Chemicals |
| | cellulose | M102D + MCC | Co. Ltd., Taiwan |
| | Distiller's dried grains | — | IGPC Ethanol Inc., |
| | with solubles | | Canada |

DS: degree of substitution

DS: degree of substitution

### General Methods

### Process 1

Process 1 is used in the preparation of the compositions that contained no fillers, unless indicated otherwise in specific examples.

### Step 1—Premixing

Pre-dried cellulose acetate powder is mixed with a plasticizer or plasticizers at the weight ratio specified in the material formulations using a stand mechanical mixer for 10 min. The mixture of cellulose acetate and plasticizer was kept in a closed bag for at least 4 h at room temperature for conditioning.

Step 2—Addition of organic peroxide Organic peroxide, at the phr level specified in the formulations of specific examples, was weighed into acetone at a one-to-one weight ratio. The resulting solution was thoroughly mixed with the cellulose acetate and plasticizer mixture obtained in Step 1—Premixing in a stand mixer for 10 min.

### Step 3—Extrusion

The mixed materials obtained in Step 2 were melt compounded at 170-200° C. in a twin-screw extruder (Leistritz™ Micro-27, Nurnberg, Germany) equipped with screws having a diameter of 27 mm and an L/D ratio of 48. The feeding rate and screw speed were 5-10 kg/h and 100 rpm, respectively. The extruded strands were pelletized and dried in a hot-air oven overnight.

### Process 2

Process 2 is used in the preparation of the compositions containing fillers, unless indicated otherwise in specific examples.

### Step 1—Premixing

Pre-dried cellulose acetate powder was mixed with a plasticizer or plasticizers at the weight ratio specified in the material formulations using a stand mechanical mixer for 10 min. The mixture of cellulose acetate and plasticizer was kept in a closed bag for 4 h at room temperature for conditioning.

### Step 2—Addition of Organic Peroxide

Organic peroxide, at the phr level specified in the formulations of specific examples was weighed into acetone at one-to-one weight ratio. The resulting solution was mixed with a filler or fillers such as talc.

When a compatibilizer was used, it was added to the pre-mixed cellulose acetate and plasticizer of Step 1 at this point.

The mixture of organic peroxide and fillers was then thoroughly mixed with the cellulose acetate and plasticizer mixture of Step 1 in a stand mixer for 10 min to obtain mixed materials.

### Step 3—Extrusion

The mixed materials were melt compounded at 170-200° C. in a twin-screw extruder (Leistritz™ Micro-27, Nurnberg, Germany) equipped with screws having a diameter of 27 mm and an L/D ratio of 48. The feeding rate and screw speed were 5-10 kg/h and 100 rpm, respectively. The extruded strands were pelletized and dried in a hot-air oven overnight.

### Test Specimen Preparation

### Injection Moulding of Standard Test Specimens

The pellets obtained by extrusion were injection moulded into specimens for mechanical and thermal property characterizations by using either a Mini-Jector™ hydraulic moulding machine (Model #55P, Miniature Plastic Moulding Corp., Solon, Ohio) or Xplore™ micro compounder with micro injection moulder (Xplore™ Instruments BV, Sittard, Limburg, The Netherlands). Injection moulding using the Mini-Jector was carried out at 200° C., with pressure values of 900 psi, 800 psi, and 800 psi (packing) in the three zones. The Xplore™ micro compounder is equipped with twin screws with an L/D ratio of 150:18. The processing temperature, screw speed, and retention time were 200-220° C., 100 rpm and 2 min, respectively. The same temperature (200-220° C.) was set for the transfer device. On the micro injection moulder, the filling, packing, and holding pressures were fixed at 12 bar with a holding time of 6 sec.

At least five specimens of each type were fabricated. The test specimens were conditioned at about 50% relative humidity and room temperature for 48 h before being tested.

### Compression Moulding of Sheets

The pellets obtained were compression moulded using a Carver™ hot press at 180 to 200° C. into sheets for cutting the square-shaped specimens used in disintegration studies and also for thermoforming.

### Shaped Articles

### Injection Moulding of Shaped Articles

The pellets of the cellulose acetate compositions obtained by extrusion were injection moulded into articles (Nespresso® and K-cup® compatible coffee capsules in some examples) by using an ARBURG™ AllRounder 370 injection moulding machine (ARBURG™ GmbH+Co KG, LoBburg, Germany). Injection moulding was performed at temperatures between 180 to 220° C., dosage volume in the range of 30 to 35 cm³, injection pressure in the range of 1000 to 2000 bar, and cooling time in the range of 2 to 20 s. Coffee capsules with different sizes and thicknesses were prepared to match the dimensions of some commercial products available in the market. Based on the unique mould design, the thickness of the coffee capsules can be reduced from 0.6 mm to 0.4 mm.

### Thermoforming of Shaped Articles

The sheets obtained by compression moulding were thermoformed using CR Clarke™ Vacuum Former 750FLB (Ammanford, UK). The heated sheet was shaped by a male mould.

### Test Protocols

The melt flow index (MFI) was measured using a melt flow indexer (Qualitest™, USA) operated at 210° C. as per ASTM D1238-20. The analysis was repeated three times for each composition to check the repeatability.

The tensile, flexural and impact specimens were prepared as per ASTM D638 (type IV), ASTM D790 and ASTM D256 standards, respectively. The tensile and flexural properties were measured by using a universal testing machine (Instron™ 3382) at testing speeds of 5 mm/min and 14 mm/min, respectively. The notched Izod impact strength was tested using a Zwick/Roell™ HIT25P impact tester equipped with a 2.5 J hammer. Five specimens of each composition were tested to obtain the average and standard deviation.

The heat deflection temperature (HDT) was measured by using the 3-point bending mode of a Q800 dynamic mechanical analyzer from TA Instruments™ (New Castle, DE, USA). The heating rate was set at 2° C./min. The HDT was determined as the temperature at which the test bar deflected 0.25 mm (0.01 in) under a flexural load of 0.455 MPa.

The glass transition temperature was tested and compared using two methods, namely differential scanning calorimetry (DSC) and dynamic mechanical analysis (DMA) in 3-point bending mode. For DMA, the sample bars were heated from room temperature to 160° C. at 3° C. per minute. DSC ramp was from 0 to 250° C. at 5° C. per minute.

The oxygen transmission rate (OTR) was measured at 0% relative humidity (RH) and 23° C. using an OX-TRAN® 2/22L system (Mocon™, USA) according to ASTM D3985.

The water vapor transmission rate (VWTR) was measured using a PERMATRAN-W® 3/33 system (Mocon™, USA) according to ASTM D6701, at 90% RH and 37.8° C.

### Biodegradation Testing

### Disintegration

The degrees of disintegration of the compositions and articles exposed to a composting environment were evaluated in accordance with ISO 20200—Plastics—Determination of The Degree of Disintegration of Plastic Materials Under Simulated Composting Conditions in a Laboratory—Scale Test. The cast films of 0.12 mm in thickness and compression moulded sheets of 0.4 mm in thickness were cut into 25 mm×25 mm squares conforming to the dimensions specified by ISO 20200. Cellulose sheets were cut to the same dimensions and served as the positive blank. The compost was prepared from a mixture of food waste and garden waste in a 1:1 ratio and adjusted to a moisture content of about 55%. The pH of the compost was 7 at the beginning. The reactors containing the samples mixed into the compost was kept in an environmental chamber maintained at 58±2° C. for thermophilic incubation. The composting procedure was carried out for 90 days.

### Marine Biodegradation

The sample pellets were reduced to powders by cryogrinding and then tested in accordance with ASTM D7991—Standard Test Method for Determining Aerobic Biodegradation of Plastics Buried in Sandy Marine Sediment under Controlled Laboratory Conditions. A ratio of 150 g of marine water to 250 g of sediment was added to each glass vessel. One hundred mg of test sample or pure cellulose (as a positive blank) was submersed in the sediment. The cellulose was used as a reference material to check the validity criteria. The marine water and sediment were stored in a cool environment for 6 weeks prior to commencing the study. The desiccators were kept in an environmental chamber maintained at 25±2° C. To ensure an airtight seal, petroleum jelly and Parafilm™ were applied at the periphery of the desiccators' lids after each titration. The desiccators were gently shaken every day to break up the CaCO₃ layer that developed from the reaction of Ba(OH)₂ and CO₂ in the glass vessels.

### Examples 1 to 5—Effect of Organic Peroxide Additives

Examples 1 to 5 demonstrate that the addition of a small amount of organic peroxide greatly enhances the melt flow of cellulose acetate compositions. It also affects the microstructure of the materials, leading to improved properties. Varying the organic peroxide contents allows the tuning of the processability and mechanical performances.

### Example 1—Organic Peroxide Used with Mineral Fillers

The compositions were prepared with Process 2 in General Methods. The polymer matrix was cellulose acetate (DS: 2.5). The plasticizer was triacetin. The organic peroxide used was technically pure 2,5-dimethyl-2,5-di(tert-butylperoxy)-hexane (CAS #78-63-7, Commercial name: Luperox® 101). The filler was talc. The materials were extruded using the Leistritz™ Micro-27 and injection moulded using the Mini-Jector™ hydraulic moulding machine. The effect of the addition of the organic peroxide (Luperox® 101 in this example) on the properties of the plasticized cellulose acetate can be seen in Table 2.

The material containing cellulose acetate and 20% triacetin as the plasticizer showed a very low melt flow index (MFI) of 2 (g/10 min) (at 210° C. and 2.16 kg). The incorporation of 25 wt % talc into cellulose acetate/triacetin (80/20) reduced the MFI further to 0.8 (g/10 min) (at 210° C. and 2.16 kg). The material became hardly processable. It is well known that the presence of rigid fillers often increases the viscosity of molten polymeric materials. Therefore, high amounts of fillers can hamper the processing of the materials.

This example shows that the addition of just 0.05 phr organic peroxide (Luperox® 101 in this example) increased the MFI. With 0.075 phr organic peroxide added, the MFI was increased to 7.5 g/10 min (at 210° C. and 2.16 kg). This MFI makes the composition suitable for injection moulding.

At the same filler content, the tensile and flexural modulus doubled with the addition of 0.05 and 0.075 phr organic peroxide. The addition of the organic peroxide enhanced the plasticization of the cellulose acetate and improved the wetting of the reinforcement by the polymer matrix. This led to enhanced load transfer.

At even higher amounts of the organic peroxide (0.2 and 0.5 phr), the modulus and strength started to decrease, while the MFI climbed quickly. Too high a content of the organic peroxide can cause side reactions that may deteriorate the properties of the polymer.

These results show that adjusting the amount of the organic peroxide additive along with the plasticizer can control the melt flow properties of plasticized cellulose acetate compositions.

TABLE 2
Effect of organic peroxide additive on the melt flow and mechanical properties of cellulose acetate compositions

| | MFI | | | | | | | |
|---|---|---|---|---|---|---|---|---|
| | (g/10 min) | Tensile | Tensile | % | % | Flexural | Flexural | Impact |
| | (210° C., | Modulus | Strength | Elongation | Elongation | Modulus | Strength | Strength |
| Formulation | 2.16 kg) | (MPa) | (MPa) | at Yield | at Break | (MPa) | (MPa) | (J/m) |
| 80% Cellulose | 2 ± 0.5 | 4174 ± 157 | 91.0 ± 1.0 | 3 ± 0.1 | 12.5 ± 0.4 | 3597 ± 39 | 94 ± 2 | 52 ± 11 |
| Acetate (DS: | | | | | | | | |
| 2.5) + 20% | | | | | | | | |
| Triacetin | | | | | | | | |
| 75% [80% | 0.8 | 6120 ± 276 | 83.9 ± 1 | 5.16 ± 1.3 | 6.04 ± 1.3 | 7281 ± 411 | 137 ± 9 | 19.8 ± 3.3 |
| Cellulose | | | | | | | | |
| Acetate (DS: | | | | | | | | |
| 2.5) + 20% | | | | | | | | |
| Triacetin + | | | | | | | | |
| 25% Talc | | | | | | | | |
| 75% [80% | 2.5 ± 0.1 | 8282 ± 284 | 81.3 ± 2.1 | 3.2 ± 0.7 | 3.2 ± 0.8 | 7754 ± 357 | 129 ± 11 | 28.2 ± 3.7 |
| Cellulose | | | | | | | | |
| Acetate (DS: | | | | | | | | |
| 2.5) + 20% | | | | | | | | |
| Triacetin] + | | | | | | | | |
| 25% Talc + | | | | | | | | |
| 0.05 phr | | | | | | | | |
| Luperox ® 101 | | | | | | | | |
| 75% [80% | 7.5 ± 0.1 | 7820 ± 494 | 89.5 ± 1.2 | 3.1 ± 0.5 | 3.7 ± 1.2 | 7182 ± 605 | 123.1 ± 2.1 | 15.0 ± 4.8 |
| Cellulose | | | | | | | | |
| Acetate (DS: | | | | | | | | |
| 2.5) + 20% | | | | | | | | |
| Triacetin] + | | | | | | | | |
| 25% Talc + | | | | | | | | |
| 0.075 phr | | | | | | | | |
| Luperox ® 101 | | | | | | | | |
| 75% [80% | 14.0 ± 0.5 | 7504 ± 195 | 58.3 ± 3.0 | 1.1 ± 0.1 | 1.2 ± 0.1 | 7400 ± 263 | 92.1 ± 9.8 | 18.3 ± 0.6 |
| Cellulose | | | | | | | | |
| Acetate (DS: | | | | | | | | |
| 2.5) + 20% | | | | | | | | |
| Triacetin] + | | | | | | | | |
| 25% Talc + | | | | | | | | |
| 0.2 phr | | | | | | | | |
| Luperox ® 101 | | | | | | | | |
| 75% [80% | 34.1 ± 0.5 | 5516 ± 300.2 | 54.9 ± 11.7 | — | 1.5 ± 0.8 | 5463 ± 208 | 71.47 ± 19 | 15.9 ± 1.2 |
| Cellulose | | | | | | | | |
| Acetate (DS: | | | | | | | | |
| 2.5) + 20% | | | | | | | | |
| Triacetin] + | | | | | | | | |
| 25% Talc + | | | | | | | | |
| 0.5 phr | | | | | | | | |
| Luperox ® 101 | | | | | | | | |

DS: degree of substitution

Compared to the cellulose acetate plasticized with triacetin, the composition containing 20% talc showed slightly higher T_{g}, 137° C. as compared to 133° C. Fillers can restrict the movement of polymer chains, causing the T_{g} to increase. The addition of organic peroxide decreased the T_{g}, to the extent that the temperatures were even slightly lower than that of the composition without fillers.

TABLE 3
Glass transition temperatures measured by DSC

| | T_{g} (° C.) of |
|---|---|
| Formulation | 2nd heating run |
| 80% Cellulose Acetate (DS: 2.5) + 20% Triacetin | 133 |
| 75% [80% Cellulose Acetate (DS: 2.5) + 20% | 137 |
| Triacetin + 25% Talc | |
| 75% [80% Cellulose Acetate (DS: 2.5) + 20% | 131 |
| Triacetin] + 25% Talc + 0.075 phr Luperox ® 101 | |
| 75% [80% Cellulose Acetate (DS: 2.5) + 20% | 129 |
| Triacetin] + 25% Talc + 0.5 phr Luperox ® 101 | |

DS: degree of substitution

It is well known that cellulose acetates show broad transition regions in DSC tests. Therefore, the T_{g} is also estimated by using the tan 5 peak of dynamic mechanical analysis (DMA). Table 4 shows again a decrease of the T_{g} with the addition of the organic peroxide. The depression of the T_{g} is a clear indication of the enhanced plasticization achieved by the present disclosure.

TABLE 4
Glass transition temperatures measured by the tan o peaks of DMA

| | T_{g} (° C.) by |
|---|---|
| Formulation | tan δ peak |
| 80% Cellulose Acetate (DS: 2.5) + 20% Triacetin | 130 |
| 75% [80% Cellulose Acetate (DS: 2.5) + 20% | 123 |
| Triacetin + 25% Talc | |
| 75% [80% Cellulose Acetate (DS: 2.5) + 20% | 116 |
| Triacetin] + 25% Talc + 0.075 phr Luperox ® 101 | |
| 75% [80% Cellulose Acetate (DS: 2.5) + 20% | 119 |
| Triacetin] + 25% Talc + 0.5 phr Luperox ® 101 | |

DS: degree of substitution

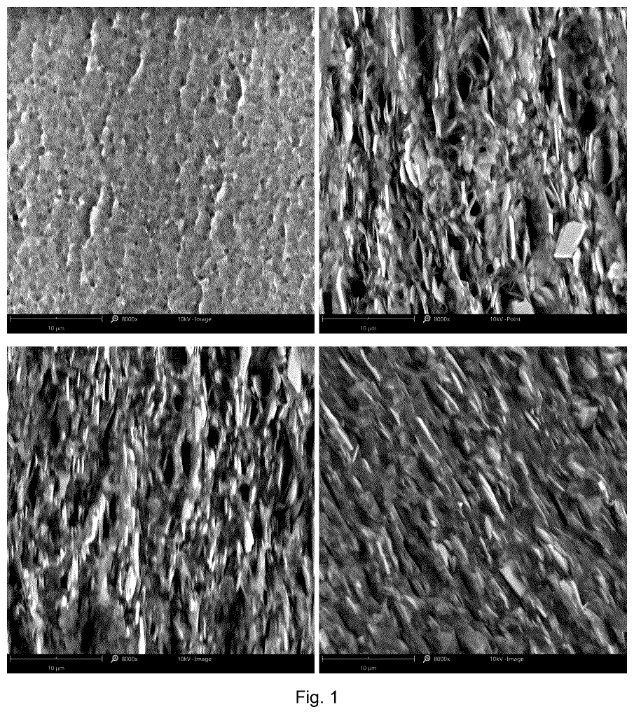

The filler particles act as effective carriers for the organic peroxide in the compositions of the present disclosure. As a result of enhanced plasticization of the cellulose acetate, there was better wetting of the talc particles, as can be seen in the electron microscope images comparing the fracture surfaces in FIG. 1. The platelets with higher contrast in the images are the talc particles. In the composition with 25% filler and no organic peroxide (top right image of FIG. 1), the talc particles showed sharp edges, indicating that they were not wet well by the polymer matrix. In the composition with 25% filler and the 0.075 phr organic peroxide (bottom left image of FIG. 1), the edges of the filler particles became difficult to distinguish. In the composition with 25% filler and the 0.5 phr organic peroxide (bottom right image of FIG. 1), the filler particles were all embedded well in the polymer matrix, indicating strong adhesion.

In summary, Example 1 shows that (a) The method of the present disclosure improves the melt flow of thermoplastic cellulose acetate, in particular with the incorporation of fillers; (b) the synergy of the plasticizer and the additive can lower the glass transition temperature of thermoplastic cellulose acetates; (c) the filler can work as a carrier to help disperse the additives; and (d) the organic peroxide additive can improve the wetting of the fillers by the polymer matrix.

### Example 2—Effect of Organic Peroxide Used with Organic Fillers

Cellulose acetate compositions were obtained in the same manner as in Example 1, except that the cellulose acetate used had a degree of substitution of 2.25, as compared to 2.5 in Example 1, and the filler used was 20% microcrystalline cellulose (MCC) powder, as compared to 25% talc in Example 1. The materials were extruded using the Leistritz™ Micro-27 and injection moulded using the Xplore™. The effect of adding organic peroxide and varying the organic peroxide contents on the MFI and mechanical properties are shown in Table 5.

With 20% MCC as filler, the composition showed a very low MFI of 5.6 (g/10 min) (210° C., 2.16 kg). With the addition of 0.03 phr organic peroxide, the MFI was increased to 12.8 (g/10 min) (210° C., 2.16 kg). The tensile and flexural moduli remained largely the same at 0.03 phr organic peroxide and started to drop at 0.07 phr organic peroxide.

Example 2 shows that the methods of the present disclosure also work with organic fillers. The MCC also facilitated the dispersion of the organic peroxide to enhance plasticization effect.

TABLE 5
Effect of adding organic peroxide to cellulose acetate compositions containing microcrystalline cellulose (MCC)

| | MFI | | | | | | | |
|---|---|---|---|---|---|---|---|---|
| | (g/10 min) | Tensile | Tensile | % | % | Flexural | Flexural | Impact |
| | (210° C., | Modulus | Strength | Elongation | Elongation | Modulus | Strength | Strength |
| Formulation | 2.16 kg) | (MPa) | (MPa) | at Yield | at Break | (MPa) | (MPa) | (J/m) |
| 80% [70% | 5.6 | 2881 ± 206 | 42.3 ± 1.13 | 3.19 ± 0.09 | 8.09 ± 0.88 | 3420 ± 32 | 68.13 ± 0.54 | 28.0 ± 1.6 |
| Cellulose | | | | | | | | |
| Acetate (DS: | | | | | | | | |
| 2.25) + 30% | | | | | | | | |
| Triacetin] + | | | | | | | | |
| 20% MCC | | | | | | | | |
| 80% [70% | 12.8 | 2726 ± 87 | 41.1 ± 0.62 | 2.88 ± 0.07 | 6.41 ± 0.94 | 3191 ± 74 | 63.38 ± 1.33 | 28.6 ± 1.8 |
| Cellulose | | | | | | | | |
| Acetate (DS: | | | | | | | | |
| 2.25) + 30% | | | | | | | | |
| Triacetin] + | | | | | | | | |
| 20% MCC + | | | | | | | | |
| 0.03 phr | | | | | | | | |
| Luperox ® 101 | | | | | | | | |
| 80% [70% | 24.6 | 2520 ± 106 | 37.4 ± 1.21 | 2.62 ± 0.06 | 3.89 ± 0.56 | 2838 ± 166 | 57.15 ± 2.16 | 28.8 ± 1.2 |
| Cellulose | | | | | | | | |
| Acetate (DS: | | | | | | | | |
| 2.25) + 30% | | | | | | | | |
| Triacetin] + | | | | | | | | |
| 20% MCC + | | | | | | | | |
| 0.07 phr | | | | | | | | |
| Luperox ® 101 | | | | | | | | |

DS: degree of substitution

### Example 3—Organic Peroxide Used with Hybrid Mineral Fillers

Cellulose acetate compositions were obtained in the same manner as in Example 1, except that the fillers used were hybrid fillers of 20% talc and 5% calcium carbonate in lieu of 25% talc in Example 1. The materials were extruded using the Leistritz™ Micro-27 and injection moulded using the Mini-Jector™ hydraulic moulding machine. The effect of adding organic peroxide and varying the organic peroxide contents on the MFI and mechanical properties are shown in Table 6.

Example 3 shows that the addition of the organic peroxide led to improved melt flow in the presence of hybrid fillers. The same trend of the initial increase of the modulus and subsequent decrease with increasing organic peroxide contents was also observed. The hybridization strategy can be used to reach desired melt flow and mechanical performances.

TABLE 6
Effect of adding organic peroxide to cellulose acetate compositions containing hybrid mineral fillers

| | MFI | | | | | | | |
|---|---|---|---|---|---|---|---|---|
| | (g/10 min) | Tensile | Tensile | % | % | Flexural | Flexural | Impact |
| | (210° C., | Modulus | Strength | Elongation | Elongation | Modulus | Strength | Strength |
| Formulation | 2.16 kg) | (MPa) | (MPa) | at Yield | at Break | (MPa) | (MPa) | (J/m) |
| 80% Cellulose | 2 | 4174 ± 157 | 91.0 ± 1.0 | 3.0 ± 0.1 | 12.5 ± 0.4 | 3597 ± 39 | 94 ± 2 | 52 ± 11 |
| Acetate (DS: | | | | | | | | |
| 2.5) + 20% | | | | | | | | |
| Triacetin | | | | | | | | |
| 75% [80% | 2.6 | 7830 ± 345 | 81.5 ± 0.2 | 3.3 ± 0.3 | 3.4 ± 1.6 | 5890 ± 299 | 105 ± 18 | 21 ± 4 |
| Cellulose | | | | | | | | |
| Acetate (DS: | | | | | | | | |
| 2.5) + 20% | | | | | | | | |
| Triacetin] + | | | | | | | | |
| 20% Talc + | | | | | | | | |
| 5% CaCO₃ + | | | | | | | | |
| 0.05 phr | | | | | | | | |
| Luperox ® 101 | | | | | | | | |
| 75% [80% | 6 | 5578 ± 190.7 | 70.8 ± 4.2 | 2.53 ± 0.58 | 2.53 ± 0.58 | 5887 ± 154 | 84 ± 6 | 13 ± 1 |
| Cellulose | | | | | | | | |
| Acetate (DS: | | | | | | | | |
| 2.5) + 20% | | | | | | | | |
| Triacetin + | | | | | | | | |
| 20% Talc + | | | | | | | | |
| 5% CaCO₃ + | | | | | | | | |
| 0.09 phr | | | | | | | | |
| Luperox ® 101 | | | | | | | | |

DS: degree of substitution

### Example 4—Effect of Organic Peroxide Used with Hybrid Mineral and Organic Fillers

Cellulose acetate compositions were obtained in the same manner as in Example 1, except that the plasticizer was triethyl citrate in lieu of triacetin, and the fillers used were hybrid fillers of 20% talc, 5% calcium carbonate, and 6% starch in lieu of 25% Talc in Example 1. The materials were extruded using the Leistritz™ Micro-27 and injection moulded using the Xplore™. The effect of adding organic peroxide and varying the organic peroxide contents on the MFI and mechanical properties are shown Table 7.

The same effect of MFI increase with increasing content of the organic peroxide was obtained.

TABLE 7
Effect of adding organic peroxide to cellulose acetate compositions containing hybrid mineral and organic fillers

| | MFI | | | | | | | |
|---|---|---|---|---|---|---|---|---|
| | (g/10 min) | Tensile | Tensile | % | % | Flexural | Flexural | Impact |
| | (210° C., | Modulus | Strength | Elongation | Elongation | Modulus | Strength | Strength |
| Formulation | 2.16 kg) | (MPa) | (MPa) | at Yield | at Break | (MPa) | (MPa) | (J/m) |
| 69% [70% | 5 | 5519 ± 304 | 46.4 ± 1.0 | 2.24 ± 0.23 | 4.89 ± 1.90 | 4559 ± 54 | 76.8 ± 1.3 | 23.2 ± 3.6 |
| Cellulose | | | | | | | | |
| Acetate (DS: | | | | | | | | |
| 2.5) + 30% | | | | | | | | |
| Triethy1 | | | | | | | | |
| Citrate] + | | | | | | | | |
| 20% Talc + | | | | | | | | |
| 5% CaCO₃ + | | | | | | | | |
| 6% Starch | | | | | | | | |
| 69% [70% | 13.5 | 3889 ± 238 | 45.7 ± 0.70 | 2.55 ± 0.03 | 5.84 ± 0.24 | 4207 ± 47 | 70.1 ± 1.2 | 24.91 ± 6.27 |
| Cellulose | | | | | | | | |
| Acetate (DS: | | | | | | | | |
| 2.5) + 30% | | | | | | | | |
| Triethyl | | | | | | | | |
| Citrate] + | | | | | | | | |
| 20% Talc + | | | | | | | | |
| 5% CaCO₃ + | | | | | | | | |
| 6% Starch + | | | | | | | | |
| 0.03 phr | | | | | | | | |
| Luperox ® 101 | | | | | | | | |
| 69% [70% | 17.5 | 3655 ± 181 | 45.8 ± 1.30 | 2.45 ± 0.05 | 4.72 ± 0.17 | 4227 ± 134 | 69.3 ± 1.8 | 19.35 ± 1.65 |
| Cellulose | | | | | | | | |
| Acetate (DS: | | | | | | | | |
| 2.5) + 30% | | | | | | | | |
| Triethy1 | | | | | | | | |
| Citrate] + | | | | | | | | |
| 20% Talc + | | | | | | | | |
| 5% CaCO₃ + | | | | | | | | |
| 6% Starch + | | | | | | | | |
| 0.04 phr | | | | | | | | |
| Luperox ® 101 | | | | | | | | |
| 69% [70% | 16.2 | 4650 ± 276 | 51.5 ± 0.09 | 2.25 ± 0.5 | 3.4 ± 0.2 | 3981 ± 94 | 67.1 ± 0.6 | 20 ± 2.5 |
| Cellulose | | | | | | | | |
| Acetate (DS: | | | | | | | | |
| 2.5) + 30% | | | | | | | | |
| Triethyl | | | | | | | | |
| Citrate] + | | | | | | | | |
| 20% Talc + | | | | | | | | |
| 5% CaCO₃ + | | | | | | | | |
| 6% Starch + | | | | | | | | |
| 0.05 phr | | | | | | | | |
| Luperox ® 101 | | | | | | | | |
| 69% [70% | 28 | 3676 ± 184.7 | 44.8 ± 0.25 | 2.43 | 3.17 ± 0.36 | 4041 ± 42 | 67.1 ± 1.8 | 17.15 ± 3.26 |
| Cellulose | | | | | | | | |
| Acetate (DS: | | | | | | | | |
| 2.5) + 30% | | | | | | | | |
| Triethyl | | | | | | | | |
| Citrate] + | | | | | | | | |
| 20% Talc + | | | | | | | | |
| 5% CaCO₃ + | | | | | | | | |
| 6% Starch + | | | | | | | | |
| 0.07 phr | | | | | | | | |
| Luperox ® 101 | | | | | | | | |

DS: degree of substitution

### Example 5—Effect of Organic Peroxide Used with Hybrid Mineral and Biocarbon Fillers

Biocarbon was obtained by pyrolyzing wood at 700° C. and milled to an average particle size below 1 μm. Cellulose acetate compositions were prepared in the same manner as in Example 1, except that the fillers used were hybrid fillers of 8% talc and 15% biocarbon. The materials were extruded using the Leistritz™ Micro-27 and injection moulded using the Xplore™. The effect of adding organic peroxide and varying the organic peroxide contents on the MFI and mechanical properties are shown Table 8.

The same effect of MFI increase with increasing content of the organic peroxide additive was observed.

TABLE 8
Effect of adding organic peroxide to cellulose acetate compositions containing hybrid mineral and biocarbon fillers

| | MFI | | | | | | | |
|---|---|---|---|---|---|---|---|---|
| | (g/10 min) | Tensile | Tensile | % | % | Flexural | Flexural | Impact |
| | (210° C., | Modulus | Strength | Elongation | Elongation | Modulus | Strength | Strength |
| Formulation | 2.16 kg) | (MPa) | (MPa) | at Yield | at Break | (MPa) | (MPa) | (J/m) |
| 77% {75% [80% | 9.2 ± 0.5 | 4852 ± 439 | 57.9 ± 4.1 | 2.4 ± 0.1 | 2.4 ± 0.2 | 4288 ± 143 | 81.8 ± 8.1 | 14.7 ± 2.1 |
| Cellulose | | | | | | | | |
| Acetate (DS: | | | | | | | | |
| 2.5) + 20% | | | | | | | | |
| Cellulose | | | | | | | | |
| Acetate (DS: | | | | | | | | |
| 2.25)] + 25% | | | | | | | | |
| Triacetin } + | | | | | | | | |
| 15% Wood | | | | | | | | |
| Biocarbon + | | | | | | | | |
| 8% Talc + | | | | | | | | |
| 0.05 phr | | | | | | | | |
| Luperox ® 101 | | | | | | | | |
| 77% {75% [80% | 9.3 | 4212 ± 102 | 57.9 ± 1.4 | 3.7 ± 0.4 | 4.3 ± 1.1 | 4233 ± 30 | 77.0 ± 4.6 | 15.6 ± 0.6 |
| Cellulose | | | | | | | | |
| Acetate (DS: | | | | | | | | |
| 2.5) + 20% | | | | | | | | |
| Cellulose | | | | | | | | |
| Acetate (DS: | | | | | | | | |
| 2.25)] + 25% | | | | | | | | |
| Triacetin} + | | | | | | | | |
| 15% Wood | | | | | | | | |
| Biocarbon + | | | | | | | | |
| 8% Talc + | | | | | | | | |
| 0.075 phr | | | | | | | | |
| Luperox ® 101 | | | | | | | | |
| 77% {75% [80% | 11.7 | 4268 ± 152 | 55.9 ± 2.2 | 2.9 ± 0.9 | 2.9 ± 1.0 | 4145 ± 87 | 79.5 ± 2.8 | 16.0 ± 2.0 |
| Cellulose | | | | | | | | |
| Acetate (DS: | | | | | | | | |
| 2.5) + 20% | | | | | | | | |
| Cellulose | | | | | | | | |
| Acetate (DS: | | | | | | | | |
| 2.25)] + 25% | | | | | | | | |
| Triacetin} + | | | | | | | | |
| 15% Wood | | | | | | | | |
| Biocarbon + | | | | | | | | |
| 8% Talc + 0.1 | | | | | | | | |
| phr | | | | | | | | |
| Luperox ® 101 | | | | | | | | |
| 77% {75% [80% | 13.4 ± 0.3 | 4012 ± 360 | 52.9 ± 2.1 | 2.3 ± 0.4 | 2.4 ± 0.4 | 4148 ± 157 | 74.1 ± 5.7 | 18.4 ± 1.0 |
| Cellulose | | | | | | | | |
| Acetate (DS: | | | | | | | | |
| 2.5) + 20% | | | | | | | | |
| Cellulose | | | | | | | | |
| Acetate (DS: | | | | | | | | |
| 2.25)] + 25% | | | | | | | | |
| Triacetin] + | | | | | | | | |
| 15% Wood | | | | | | | | |
| Biocarbon + | | | | | | | | |
| 8% Talc + | | | | | | | | |
| 0.15 phr | | | | | | | | |
| Luperox ® 101 | | | | | | | | |

DS: degree of substitution

### Examples 6-9—Effect of Organic Peroxide in Combination with Different Plasticizers

Examples 6 to 9 demonstrate that: A) The effective plasticization of cellulose acetate in this disclosure is produced by the synergistic effect of plasticizers and organic peroxide; and B) Adjusting the combinations provides a method for tuning or tailoring the melt flow and mechanical properties of the cellulose acetate compositions.

### Example 6—Comparison of Different Plasticizers Used with the Same Organic Peroxide

Cellulose acetate compositions were prepared in the same manner as in Example 4, except that the plasticizers in the two comparative samples were triacetin and triethyl citrate, respectively. The materials were extruded using the Leistritz™ Micro-27 and injection moulded using the Xplore™.

Table 9 compares the effect of triethyl citrate and triacetin. With the same contents of fillers and organic peroxide, the cellulose acetate composition containing triethyl citrate showed a MFI of 16.2 (g/10 min) (210° C., 2.16 kg), while the composition containing triacetin showed a MFI of 33.8 (g/10 min) (210° C., 2.16 kg). This demonstrates that the enhancement of cellulose acetate plasticization is the synergistic effect of plasticizer and organic peroxide. The resultant melt flow behavior is still dependent on the plasticizer used.

TABLE 9
Effect of organic peroxide additive used with different plasticizers

| | MFI | | | | | | | |
|---|---|---|---|---|---|---|---|---|
| | (g/10 min) | Tensile | Tensile | % | % | Flexural | Flexural | Impact |
| | (210° C., | Modulus | Strength | Elongation | Elongation | Modulus | Strength | Strength |
| Formulation | 2.16 kg) | (MPa) | (MPa) | at Yield | at Break | (MPa) | (MPa) | (J/m) |
| 69% [70% | 33.8 | 4145 ± 245 | 36.7 ± 1.09 | 2.1 ± 0.13 | 2.66 ± 0.66 | 4109 ± 230 | 56.2 ± 3.1 | 20.61 ± 4.46 |
| Cellulose | | | | | | | | |
| Acetate (DS: | | | | | | | | |
| 2.5) + 30% | | | | | | | | |
| Triacetin] + | | | | | | | | |
| 20% Talc + | | | | | | | | |
| 5% CaCO₃ + | | | | | | | | |
| 6% Starch + | | | | | | | | |
| 0.05 phr | | | | | | | | |
| Luperox ® 101 | | | | | | | | |
| 69% [70% | 16.2 ± 0.5 | 4650 ± 276 | 51.5 ± 0.09 | 2.25 ± 0.5 | 3.4 ± 0.2 | 3981 ± 94 | 67.1 ± 0.6 | 20 ± 2.5 |
| Cellulose | | | | | | | | |
| Acetate (DS: | | | | | | | | |
| 2.5) + 30% | | | | | | | | |
| Triethyl | | | | | | | | |
| Citrate] + | | | | | | | | |
| 20% Talc + | | | | | | | | |
| 5% CaCO₃ + | | | | | | | | |
| 6% Starch + | | | | | | | | |
| 0.05 phr | | | | | | | | |
| Luperox ® 101 | | | | | | | | |

DS: degree of substitution

### Example 7—Another Comparison of Different Plasticizers Used with the Same Organic Peroxide

Cellulose acetate compositions were prepared in the same manner as in Example 5 except that the plasticizer used in the two comparative samples were triacetin and triethyl citrate, respectively. The materials were extruded using the Leistritz™ Micro-27 and injection moulded using the Xplore™.

Table 10 compares the effect of using triacetin and triethyl citrate as plasticizers in biocarbon and talc filled cellulose acetate compositions. Consistent with Example 6, the triacetin showed a stronger plasticization effect than triethyl citrate, in the presence of the organic peroxide additive. The mechanical properties were nearly the same.

Example 7 shows that: (a) The method of the invention can be used with different plasticizers to achieve different melt flow properties; and (b) The organic peroxide helps make the cellulose acetate compositions melt processable, without sacrificing the mechanical properties.

TABLE 10
Effect of organic peroxide additive used with different plasticizers.

| | MFI | | | | | | | |
|---|---|---|---|---|---|---|---|---|
| | (g/10 min) | Tensile | Tensile | % | % | Flexural | Flexural | Impact |
| | (210° C., | Modulus | Strength | Elongation | Elongation | Modulus | Strength | Strength |
| Formulation | 2.16 kg) | (MPa) | (MPa) | at Yield | at Break | (MPa) | (MPa) | (J/m) |
| 77% {75% [80% | 9.2 ± 0.5 | 4852 ± 439 | 57.9 ± 3.1 | 2.4 ± 0.1 | 2.4 ± 0.2 | 4288 ± 143 | 81.8 ± 8.1 | 14.7 ± 2.1 |
| Cellulose | | | | | | | | |
| Acetate (DS: | | | | | | | | |
| 2.5) + 20% | | | | | | | | |
| Cellulose | | | | | | | | |
| Acetate (DS: | | | | | | | | |
| 2.25)] + 25% | | | | | | | | |
| Triacetin} + | | | | | | | | |
| 15% Wood | | | | | | | | |
| Biocarbon + | | | | | | | | |
| 8% Talc + | | | | | | | | |
| 0.05 phr | | | | | | | | |
| Luperox ® 101 | | | | | | | | |
| 77% {75% [80% | 6.6 ± 0.3 | 4835 ± 91 | 55.4 ± 1.9 | 2.0 ± 0.3 | 2.0 ± 0.2 | 4193 ± 34 | 79.4 ± 9.0 | 14.8 ± 0.7 |
| Cellulose | | | | | | | | |
| Acetate (DS: | | | | | | | | |
| 2.5) + 20% | | | | | | | | |
| Cellulose | | | | | | | | |
| Acetate (DS: | | | | | | | | |
| 2.25] (Oven | | | | | | | | |
| dried)} + | | | | | | | | |
| 25% Triethyl | | | | | | | | |
| Citrate] + | | | | | | | | |
| 15% Wood | | | | | | | | |
| Biocarbon + | | | | | | | | |
| 8% Talc + | | | | | | | | |
| 0.05 phr | | | | | | | | |
| Luperox ® 101 | | | | | | | | |

DS: degree of substitution

### Example 8—Effect of Organic Peroxide Used with Hybrid Plasticizers

Cellulose acetate compositions were obtained in a manner analogous to Example 1. The plasticizers used in the three comparative samples were triethyl citrate, triacetin, and hybrid triethyl citrate and triacetin, respectively. The materials were extruded using the Leistritz™ Micro-27 and injection moulded using the Xplore™.

Table 11 compares the effect of using triethyl citrate or triacetin alone with that of using hybrid plasticizers in talc and starch filled cellulose acetate compositions. The cellulose acetate composition containing 30% triacetin showed higher MFI and lower modulus than the composition containing 30% triethyl citrate, suggesting a stronger plasticization effect of the former than the latter. The composition containing hybrid plasticizers showed a MFI value between those of the compositions containing triethyl citrate or triacetin alone. This example corroborates the synergistic effect of plasticizer and organic peroxide.

TABLE 11
Effect of organic peroxide additive used with hybrid plasticizers.

| | MFI | | | | | | | |
|---|---|---|---|---|---|---|---|---|
| | (g/10 min) | Tensile | Tensile | % | % | Flexural | Flexural | Impact |
| | (210° C., | Modulus | Strength | Elongation | Elongation | Modulus | Strength | Strength |
| Formulation | 2.16 kg) | (MPa) | (MPa) | at Yield | at Break | (MPa) | (MPa) | (J/m) |
| 69% [70% | 20.6 | 5138 ± 80 | 44.8 ± 0.49 | 2.03 ± 0.06 | 2.67 ± 0.37 | 4627 ± 132 | 64.4 ± 1.9 | 18.7 ± 1.3 |
| Cellulose | | | | | | | | |
| Acetate (DS: | | | | | | | | |
| 2.5) + 30% | | | | | | | | |
| Triethyl | | | | | | | | |
| Citrate] + | | | | | | | | |
| 25% Talc | | | | | | | | |
| (JetFil700C) + | | | | | | | | |
| 6% Starch | | | | | | | | |
| (Hylon) + | | | | | | | | |
| 0.05 phr | | | | | | | | |
| Luperox ® 101 | | | | | | | | |
| 69% [70% | 29.9 | 3869 ± 346.04 | 44.5 ± 0.39 | 2.28 ± 0.28 | 3.02 ± 0.71 | 4579 ± 55 | 63.5 ± 1.8 | 20.8 ± 3.4 |
| Cellulose | | | | | | | | |
| Acetate (DS: | | | | | | | | |
| 2.5) + 30% | | | | | | | | |
| Triacetin] + | | | | | | | | |
| 25% Talc + | | | | | | | | |
| 6% Starch + | | | | | | | | |
| 0.05 phr | | | | | | | | |
| Luperox ® 101 | | | | | | | | |
| 69% [70% | 23.8 | 3739 ± 125.37 | 46.8 ± 0.72 | 2.43 ± 0.02 | 3.23 ± 0.29 | 4452 ± 57 | 67.4 ± 1.4 | 19.0 ± 0.8 |
| Cellulose | | | | | | | | |
| Acetate (DS: | | | | | | | | |
| 2.5) + 15% | | | | | | | | |
| Triethyl | | | | | | | | |
| Citrate + | | | | | | | | |
| 15% Triacetin] + | | | | | | | | |
| 25% Talc + | | | | | | | | |
| 6% Starch + | | | | | | | | |
| 0.05 phr | | | | | | | | |
| Luperox ® 101 | | | | | | | | |

DS: degree of substitution

### Example 9—Hybrid Plasticizers Used with Higher Content of Organic Peroxide than Previous Example

Cellulose acetate compositions were prepared in a manner analogous to Example 1. The plasticizer was triacetin in one of the two comparative samples and a 50/50 mixture of triacetin and triethyl citrate in the other. The materials were extruded using the Leistritz™ Micro-27 and injection moulded using the Xplore™.

Table 12 compares the effect of using triacetin alone and a hybrid of triacetin and triethyl citrate as plasticizers in cellulose acetate compositions. In this case, the composition containing hybrid plasticizers showed similar MFI and slightly lower modulus and strength than the composition containing only triacetin.

TABLE 12
Effect of organic peroxide additive used with hybrid plasticizers.

| | MFI | | | | | | | |
|---|---|---|---|---|---|---|---|---|
| | (g/10 min) | Tensile | Tensile | % | % | Flexural | Flexural | Impact |
| | (210° C., | Modulus | Strength | Elongation | Elongation | Modulus | Strength | Strength |
| Formulation | 2.16 kg) | (MPa) | (MPa) | at Yield | at Break | (MPa) | (MPa) | (J/m) |
| 77% {75% [80% | 8.2 ± 1.0 | 3936 ± 137 | 57.5 ± 2.1 | 2.9 ± 0.2 | 2.9 ± 0.2 | 4664 ± 221 | 80.9 ± 3.8 | 15.1 ± 0.8 |
| Cellulose | | | | | | | | |
| Acetate (DS: | | | | | | | | |
| 2.5) + 20% | | | | | | | | |
| Cellulose | | | | | | | | |
| Acetate (DS: | | | | | | | | |
| 2.25)} + 25% | | | | | | | | |
| Triacetin] + | | | | | | | | |
| 15% Wood | | | | | | | | |
| Biocarbon + | | | | | | | | |
| 3% Talc + 5% | | | | | | | | |
| Graphite + | | | | | | | | |
| 0.09 phr | | | | | | | | |
| Luperox ® 101 | | | | | | | | |
| 77% {75% [80% | 8.5 ± 1.0 | 3735 ± 99 | 55.8 ± 1.3 | 2.9 ± 0.1 | 2.9 ± 0.1 | 4420 ± 64 | 77.1 ± 4.9 | 15.3 ± 1.1 |
| Cellulose | | | | | | | | |
| Acetate (DS: | | | | | | | | |
| 2.5) + 20% | | | | | | | | |
| Cellulose | | | | | | | | |
| Acetate (DS: | | | | | | | | |
| 2.25)} + 12.5% | | | | | | | | |
| Triacetin + | | | | | | | | |
| 12.5% Triethyl | | | | | | | | |
| Citrate} + | | | | | | | | |
| 15% Wood | | | | | | | | |
| Biocarbon + | | | | | | | | |
| 3% Talc + 5% | | | | | | | | |
| Graphite + | | | | | | | | |
| 0.09 phr | | | | | | | | |
| Luperox ® 101 | | | | | | | | |

DS: degree of substitution

### Examples 10 and 11—Cellulose Acetates of Different Degrees of Substitution

Examples 10 and 11 demonstrate that: (a) The method and compositions of present disclosure work with cellulose acetates of different degrees of substitution; and (b) cellulose acetates of different degrees of substitution can be combined to yield the desired melt flow and mechanical properties.

### Example 10—Cellulose Acetates of Different Degrees of Substitution

Cellulose acetate compositions were prepared in a manner analogous to Example 1. The polymer matrix was cellulose acetate (DS: 2.25) in one of the two comparative samples and cellulose acetate (DS: 2.5) in the other. The plasticizer was triacetin. The organic peroxide used was technically pure 2,5-dimethyl-2,5-di(tert-butylperoxy)-hexane (CAS #78-63-7, Commercial name: Luperox® 101). The fillers were talc, calcium carbonate, and starch. The materials were extruded using the Leistritz™ Micro-27 and injection moulded using the Xplore™.

Example 10 shows that the addition of organic peroxide improves the MFI of both cellulose acetate (DS: 2.25) and cellulose acetate (DS: 2.5) compositions (Table 13). As expected, the cellulose acetate (DS: 2.5) showed higher MFI because of its higher degree of substitution.

TABLE 13
Effect of using cellulose acetates with different degrees of substitution

| | MFI | | | | | | | |
|---|---|---|---|---|---|---|---|---|
| | (g/10 min) | Tensile | Tensile | % | % | Flexural | Flexural | Impact |
| | (210° C., | Modulus | Strength | Elongation | Elongation | Modulus | Strength | Strength |
| Formulation | 2.16 kg) | (MPa) | (MPa) | at Yield | at Break | (MPa) | (MPa) | (J/m) |
| 69% [70% | 17 | 4570 ± 184 | 42.8 ± 1.1 | 2.49 ± 0.1 | 3.27 ± 0.50 | 4261 ± 73 | 65.7 ± 0.9 | 20.85 ± 1.96 |
| Cellulose | | | | | | | | |
| Acetate (DS: | | | | | | | | |
| 2.25) + 30% | | | | | | | | |
| Triacetin] + | | | | | | | | |
| 20% Talc + | | | | | | | | |
| 5% CaCO₃ + | | | | | | | | |
| 6% Starch + | | | | | | | | |
| 0.05 phr | | | | | | | | |
| Luperox ® 101 | | | | | | | | |
| 69% [70% | 34 | 4145 ± 245 | 36.7 ± 1.09 | 2.1 ± 0.13 | 2.66 ± 0.66 | 4109 ± 230 | 56.2 ± 3.1 | 20.61 ± 4.46 |
| Cellulose | | | | | | | | |
| Acetate (DS: | | | | | | | | |
| 2.5) + 30% | | | | | | | | |
| Triacetin] + | | | | | | | | |
| 20% Talc + | | | | | | | | |
| 5% CaCO₃ + | | | | | | | | |
| 6% Starch + | | | | | | | | |
| 0.05 phr | | | | | | | | |
| Luperox ® 101 | | | | | | | | |

DS: degree of substitution

### Example 11—Combination of Cellulose Acetates of Different Degrees of Substitution

Cellulose acetate compositions were prepared in a manner analogous to Example 1. The polymer matrix was cellulose acetate (DS: 2.5) in one of the two comparative samples and 70% cellulose acetate (DS: 2.5)+30% cellulose acetate (DS: 2.25) in the other. The plasticizer was triethyl citrate. The organic peroxide used was technically pure 2,5-dimethyl-2,5-di(tert-butylperoxy)-hexane (CAS #78-63-7, Commercial name: Luperox® 101). The fillers were talc, calcium carbonate, and starch. The materials were extruded using the Leistritz™ Micro-27 and injection moulded using the Xplore™.

Table 14 compares the effect of using cellulose acetates of different degrees of substitution. The two compositions showed similar MFI values. The composition with the hybrid cellulose acetate (DS: 2.5) and cellulose acetate (DS: 2.25) showed lower tensile modulus and strength and impact strength but comparable flexural properties to the composition with cellulose acetate (DS: 2.5) alone.

TABLE 14
Combination of cellulose acetates with different degrees of substitution

| | MFI | | | | | | | |
|---|---|---|---|---|---|---|---|---|
| | (g/10 min) | Tensile | Tensile | % | % | Flexural | Flexural | Impact |
| | (210° C., | Modulus | Strength | Elongation | Elongation | Modulus | Strength | Strength |
| Formulation | 2.16 kg) | (MPa) | (MPa) | at Yield | at Break | (MPa) | (MPa) | (J/m) |
| 69% [70% | 16.2 | 4650 ± 276 | 51.5 ± 0.09 | 2.25 ± 0.5 | 3.4 ± 0.2 | 3981 ± 94 | 67.1 ± 0.6 | 20 ± 2.5 |
| Cellulose | | | | | | | | |
| Acetate (DS: | | | | | | | | |
| 2.5) + 30% | | | | | | | | |
| Triethyl | | | | | | | | |
| Citrate] + | | | | | | | | |
| 20% Talc + | | | | | | | | |
| 5% CaCO₃ + | | | | | | | | |
| 6% Starch + | | | | | | | | |
| 0.05 phr | | | | | | | | |
| Luperox ® 101 | | | | | | | | |
| 69% [70% (70% | 17.4 | 4263 ± 287 | 42.7 ± 0.61 | 2.3 ± 0.08 | 3.21 ± 0.31 | 4114 ± 192 | 64.18 ± 2.9 | 17.19 ± 2.3 |
| Cellulose | | | | | | | | |
| Acetate (DS: | | | | | | | | |
| 2.5) + 30% | | | | | | | | |
| Cellulose | | | | | | | | |
| Acetate (DS: | | | | | | | | |
| 2.25)) + 30% | | | | | | | | |
| Triethyl | | | | | | | | |
| Citrate] + | | | | | | | | |
| 20% Talc + | | | | | | | | |
| 5% CaCO₃ + | | | | | | | | |
| 6% Starch + | | | | | | | | |
| 0.05 phr | | | | | | | | |
| Luperox ® 101 | | | | | | | | |

DS: degree of substitution

### Examples 12-17—Organic Peroxide with Acid Anhydride

Examples 12 to 17 demonstrate that: A) the addition of organic peroxide and acid anhydride makes cellulose acetate compositions melt processable; B) the present disclosure enables the synthesis of anhydride-grafted compatibilizers from thermoplastic cellulose acetates; and C) the inclusion of anhydride-grafted compatibilizers benefits properties such as modulus and heat deflection temperature (HDT).

### Example 12—Preparation of Anhydride-Grafted Cellulose Acetate Compatibilizer

Step 1: Cellulose acetate was mixed with plasticizer (triacetin in this example) and kept in a closed bag for 4 h at room temperature for conditioning.

The sample that contained no organic peroxide and acid anhydride was extruded directly after this step. The sample that contained organic peroxide and acid anhydride was processed further in the following steps.

Step 2: The cellulose acetate and plasticizer mixture was weighed and mixed with 2.5% maleic anhydride powder using a stand mixer. Organic peroxide (Luperox® 101 in this example), at 0.5 phr of the mixture, was dissolved in acetone at a 1:1 weight ratio before being added to the mixture, and then mixed thoroughly for 10 min.

Step 3: Reactive Extrusion was performed using the Leistritz™ Micro-27 twin-screw extruder, at 175-180° C., with a screw speed of 60 rpm and feed rate of 6 kg/h.

The pellets were kept in a vacuum oven at 60° C. for 2 days to remove the unreacted maleic anhydride.

Cellulose acetate mixed with plasticizer alone is difficult to process. In this invention, the cellulose acetate was plasticized with the plasticizer and organic peroxide and synthesized into anhydride-grafted compatibilizer in a single extrusion step.

### Example 13—Preparation of Anhydride-Grafted Compatibilizer with a Filler

Differing from Example 12, this example mixed the organic peroxide with a filler first before adding them to the cellulose acetate.
Step 1: Cellulose acetate was mixed with plasticizer (biobased triacetin in this example) and kept in a closed bag for 4 h at room temperature for conditioning.
Step 2: The cellulose acetate and plasticizer mixture was weighed and mixed with 2.5% maleic anhydride powder using a stand mixer.
Organic peroxide (Luperox® 101 in this example), at 0.5 phr with respect to the total weight of the cellulose acetate, plasticizer, and filler, was dissolved in acetone at a 1:1 weight ratio and mixed with the talc before being added to the mixture.
Mixed thoroughly for 10 min.
Step 3: Reactive Extrusion was performed using the Leistritz™ Micro-27 twin-screw extruder, at 175-180° C., with a screw speed of 60 rpm and feed rate of 6 kg/h.

The pellets were kept in a vacuum oven at 60° C. for 2 days to remove the unreacted maleic anhydride.

In Example 13, the composition containing 15% talc showed low MFI, even with the presence of plasticizer. The organic peroxide additive helped increase the MFI. Higher plasticizer content led to a further increase of the MFI.

The method of the invention enables the preparation of anhydride-grafted cellulose acetate, with and without the addition of fillers in the preparation.

TABLE 15
Effect of increasing plasticizer contents in the preparation
of anhydride-grafted compatibilizer with a filler.

| | MFI (g/10 min) |
|---|---|
| Compositions | (210° C., 2.16 kg) |
| 85% {97.5% [85% Cellulose Acetate (DS: 2.5) + | 10.5 ± 0.3 |
| 15% Biobased Triacetin] + 2.5% Maleic | |
| Anhydride} + 15% Talc + 0.5 phr Luperox ® 101 | |
| 85% {97.5% [80% Cellulose Acetate (DS: 2.5) + | 28.0 ± 1.2 |
| 20% Biobased Triacetin] + 2.5% Maleic | |
| Anhydride} + 15% Talc + 0.5 phr Luperox ® 101 | |
| 85% {97.5% [75% Cellulose Acetate (DS: 2.5) + | 60.2 ± 3.6 |
| 25% Biobased Triacetin] + 2.5% Maleic | |
| Anhydride} + 15% Talc + 0.5 phr Luperox ® 101 | |

MFI: melt flow index;
DS: degree of substitution

### Example 14—Preparation of Anhydride-Grafted Compatibilizer with Different Filler Contents

The cellulose acetate compositions were obtained in the same manner as in Example 13, with the filler content varying from 0 to 5, 10, and 15% (Table 16).

Example 14 shows that increasing filler contents led to a decrease of the MFI, as is common with the addition of rigid fillers. The additives helped maintain the high MFI.

TABLE 16
Effect of increasing filler contents in the preparation
of anhydride-grafted compatibilizer

| | MFI (g/10 min) |
|---|---|
| Compositions | (210° C., 2.16 kg) |
| 97.5% [80% Cellulose Acetate (DS: 2.5) + | 36.8 ± 1.0 |
| 20% Biobased Triacetin] + 2.5% Maleic | |
| Anhydride + 0.5 phr Luperox ® 101 | |
| 95% {97.5% [80% Cellulose Acetate (DS: 2.5) + | 38.6 ± 0.8 |
| 20% Biobased Triacetin] + 2.5% Maleic | |
| Anhydride} + 5% Talc + 0.5 phr Luperox ® 101 | |
| 90% {97.5% [80% Cellulose Acetate (DS: 2.5) + | 31.8 ± 1.0 |
| 20% Biobased Triacetin] + 2.5% Maleic | |
| Anhydride} + 10% Talc + 0.5 phr Luperox ® 101 | |
| 85% {97.5% [80% Cellulose Acetate (DS: 2.5) + | 28.0 ± 1.2 |
| 20% Biobased Triacetin] + 2.5% Maleic | |
| Anhydride} + 15% Talc + 0.5 phr Luperox ® 101 | |

MFI: melt flow index;
DS: degree of substitution

### Example 15—Effect of Using the Anhydride-Grafted Compatibilizer

Maleic anhydride grafted cellulose acetate (CA-g-MA) was prepared with the method as detailed in Example 13. The CA-g-MA contained 8% talc. The maleic anhydride grafted cellulose acetate is added as a compatibilizer to the cellulose acetate compositions prepared according to Process 2 in General Methods. The pellets obtained by extrusion were injection moulded into test specimens by using the Mini-Jector™ hydraulic moulding machine.

As shown in Table 17, while the composition containing 25% filler and 3% compatibilizer had a very low MFI of 2.0 (g/10 min) (210° C., 2.16 kg), the addition of 0.025 phr organic peroxide increased the value and the addition of 0.075 phr organic peroxide improved it to 7.8 (g/10 min) (210° C., 2.16 kg), suitable for injection moulding and other processing.

Example 15 shows that the method has the same effect in improving the melt flow of thermoplastic cellulose acetate when used together with anhydride-grafted compatibilizers.

TABLE 17
Effect of compatibilizer addition

| | MFI (g/10 min) |
|---|---|
| Compositions | (210° C., 2.16 kg) |
| 72% [78% Cellulose Acetate (DS: 2.5) + 22% | 2.0 ± 0.1 |
| Triacetin] + 3% CA-g-MA (with 8% Talc) + | |
| 25% Talc | |
| 72% [78% Cellulose Acetate (DS: 2.5) + 22% | 3.0 ± 0.1 |
| Triacetin] + 3% CA-g-MA (with 8% Talc) + | |
| 25% Talc + 0.025 phr Luperox ® 101 | |
| 72% [78% Cellulose Acetate (2.5) + 22% | 7.8 ± 0.1 |
| Triacetin] + 3% CA-g-MA (with 8% Talc)] + | |
| 25% Talc + 0.075 phr Luperox ® 101 | |

MFI: melt flow index;
DS: degree of substitution

### Example 16—Effect of Compatibilizer Contents

Maleic anhydride grafted cellulose acetate (CA-g-MA) was prepared in the same manner as in Example 13. The CA-g-MA is added as a compatibilizer to the cellulose acetate compositions prepared according to Process 2 in General Methods. The contents of CA-g-MA varied from 0 to 3, 5, and 7% in this example. The pellets obtained by extrusion were injection moulded into test specimens by using the Mini-Jector™ hydraulic moulding machine.

The use of organic peroxide along with the filler in this example made it possible to synthesize the anhydride-grafted compatibilizer. The addition of small concentrations of the compatibilizer in the compositions led to improved modulus, impact strength, and HDT (Tables 18a and 18b). A high HDT is beneficial for applications in food service. Additionally, the higher tensile and flexural moduli may indicate improved load transfer.

When the compatibilizer content was increased to 7%, the MFI and impact strength started to decrease.

TABLE 18a
Effect of increasing compatibilizer
contents on the melt flow and HDT

| | MFI (g/10 min) | |
|---|---|---|
| | (210° C., | HDT |
| Formulation | 2.16 kg) | (° C.) |
| 75% [78% Cellulose Acetate (DS: 2.5) + | 11.0 ± 0.02 | 87 |
| 22% Triacetin] + 25% Talc + 0.075 phr | | |
| Luperox ® 101 | | |
| 72% [78% Cellulose Acetate (DS: 2.5) + | 11.5 ± 0.5 | 89 |
| 22% Triacetin] + 3% CA-g-MA (with 8% | | |
| Talc) + 25% Talc + 0.075 phr Luperox ® 101 | | |
| 70% [78% Cellulose Acetate (DS: 2.5) + | 10.2 ± 0.2 | 89 |
| 22% Triacetin] + 5% CA-g-MA (with 8% | | |
| Talc) + 25% Talc + 0.075 phr Luperox ® 101 | | |
| 68% [78% Cellulose Acetate (DS: 2.5) + | 8.5 | 91 |
| 22% Triacetin] + 7% CA-g-MA (with 8% | | |
| Talc) + 25% Talc + 0.075 phr Luperox ® 101 | | |

TABLE 18b
Effect on mechanical properties

| | Tensile | Tensile | % | % | Flexural | Flexural | Impact |
|---|---|---|---|---|---|---|---|
| | Modulus | Strength | Elongation | Elongation | Modulus | Strength | Strength |
| Formulation | (MPa) | (MPa) | at Yield | at Break | (MPa) | (MPa) | (J/m) |
| 75% [78% Cellulose | 7202 ± 572 | 81.8 ± 1.9 | 3.4 ± 0.2 | 5.5 ± 1.0 | 5633 ± 121 | 105.9 ± 1.8 | 16.3 ± 1.8 |
| Acetate (DS: 2.5) + | | | | | | | |
| 22% Triacetin] + | | | | | | | |
| 25% Talc + 0.075 phr | | | | | | | |
| Luperox ® 101 | | | | | | | |
| 72% [78% Cellulose | 7403 ± 272 | 67.2 ± 2.0 | 2.52 ± 0.58 | 2.64 ± 0.73 | 6576 ± 162 | 117.3 ± 1.5 | 33.0 ± 2.5 |
| Acetate (DS: 2.5) + | | | | | | | |
| 22% Triacetin] + 3% | | | | | | | |
| CA-g-MA (with 8% | | | | | | | |
| Talc) + 25% Talc + | | | | | | | |
| 0.075 phr Luperox ® 101 | | | | | | | |
| 70% [78% Cellulose | 7485 ± 200 | 63.0 ± 2.2 | 2.23 ± 0.52 | 2.23 ± 0.63 | 6112 ± 582 | 82.8 ± 5.3 | 27.6 ± 4.0 |
| Acetate (DS: 2.5) + | | | | | | | |
| 22% Triacetin] + 5% | | | | | | | |
| CA-g-MA (with 8% | | | | | | | |
| Talc) + 25% Talc + | | | | | | | |
| 0.075 phr Luperox ® 101 | | | | | | | |
| 68% [78% Cellulose | 7558 ± 353 | 71.9 ± 0.9 | 3.62 ± 0.43 | 4.66 ± 1.04 | 6999 ± 322 | 119.8 ± 4.5 | 16.0 ± 1.3 |
| Acetate (DS: 2.5) + | | | | | | | |
| 22% Triacetin] + 7% | | | | | | | |
| CA-g-MA (with 8% | | | | | | | |
| Talc) + 25% Talc + | | | | | | | |
| 0.075 phr Luperox ® 101 | | | | | | | |

DS: degree of substitution

### Example 17—Effect of Compatibilizer Used with Hybrid Fillers

The compatibilizer and the cellulose acetate compositions were obtained in a manner analogous to Example 15. The pellets obtained by extrusion were injection moulded into test specimens by using the Mini-Jector™ hydraulic moulding machine.

Compared with the sample filled with 25% talc, the sample filled with 20% talc plus 5% calcium carbonate showed slightly lower MFI (Table 19a). The latter had slightly lower modulus and strength but similar HDT (Tables 19a and 19b). The hybridization of the fillers provides an additional strategy for tuning the melt flow property without sacrificing the mechanical and thermal performances.

Example 17 shows that the melt flow and mechanical properties of the cellulose acetate compositions can be tuned with the hybridization of fillers.

TABLE 19a
Effect of compatibilizer used with hybrid
fillers on the melt flow and HDT

| | MFI (g/10 min) | |
|---|---|---|
| | (210° C., | HDT |
| Formulation | 2.16 kg) | (° C.) |
| 70% [79% Cellulose Acetate (DS: 2.5) + 21% | 9.0 | 92.5 |
| Triacetin] + 5% CA-g-MA (with 8% Talc) + | | |
| 25% Talc + 0.075 phr Luperox ® 101 | | |
| 70% [79% Cellulose Acetate (DS: 2.5) + 21% | 6.5 | 94.4 |
| Triacetin] + 5% CA-g-MA (with 8% Talc) + 20% | | |
| Talc + 5% CaCO₃ + 0.075 phr Luperox ® 101 | | |

TABLE 19b
Effect on mechanical properties

| | Tensile | Tensile | % | % | Flexural | Flexural | Impact |
|---|---|---|---|---|---|---|---|
| | Modulus | Strength | Elongation | Elongation | Modulus | Strength | Strength |
| Formulation | (MPa) | (MPa) | at Yield | at Break | (MPa) | (MPa) | (J/m) |
| 70% [79% Cellulose | 4926 ± 242.1 | 68 ± 3.79 | 3.33 ± 0.93 | 3.76 ± 1.22 | 5667 ± 273.7 | 101.24 ± 7.89 | 24.7 ± 9.9 |
| Acetate (DS: 2.5) + | | | | | | | |
| 21% Triacetin] + 5% | | | | | | | |
| CA-g-MA (with 8% | | | | | | | |
| Talc) + 25% Talc + | | | | | | | |
| 0.075 phr Luperox ® 101 | | | | | | | |
| 70% [79% Cellulose | 4585 ± 310.2 | 66.1 ± 0.68 | 3.31 ± 0.43 | 3.47 ± 0.45 | 5356 ± 257 | 95.43 ± 7.56 | 17.4 ± 2.7 |
| Acetate (DS: 2.5) + | | | | | | | |
| 21% Triacetin] + 5% | | | | | | | |
| CA-g-MA (with 8% | | | | | | | |
| Talc) + 20% Talc + | | | | | | | |
| 5% CaCO₃ + | | | | | | | |
| 0.075 phr Luperox ® 101 | | | | | | | |

DS: degree of substitution

### Examples 18-20—Disintegration

Examples 18-20 demonstrate that the cellulose acetate compositions pass the 90% disintegration mark in 90 days under simulated composting conditions.

In Example 18, the cellulose acetate composition was obtained in the same manner as in Example 3, with the formulation given in Table 20. The pellets obtained by extrusion were cast into films of 0.12 mm thickness by using a blown/cast film line of COLLIN Lab & Pilot Solutions GmbH (Maitenbeth, Germany). The film was cut into small pieces and used to determine the degree of disintegration under simulated composting conditions in accordance with ISO 20200—Plastics—Determination of the degree of disintegration of plastic materials under simulated composting conditions in a laboratory-scale test.

In Example 19, the cellulose acetate composition was prepared in the same manner as in Example 17, with the formulation given in Table 20. The pellets obtained by extrusion were compression moulded into sheets. Small pieces cut out from the sheets were tested for the degree of disintegration in accordance with ISO 20200.

In Example 20, the cellulose acetate composition was prepared in a manner analogous to Example 16, except that 5% alkyl ketene dimer (AKD) was added. The pellets obtained by extrusion were compression moulded into sheets. Small pieces cut out from the sheets were tested for the degree of disintegration in accordance with ISO 20200.

TABLE 20
Disintegration after composting at 58° C. for 90 days

| | | Preparation | Thickness | % |
|---|---|---|---|---|
| Example # | Composition | Technique | [mm] | Disintegration |
| Reference | Cellulose (Sigma Aldrich) | | — | 100 |
| Example | 85% [75% Cellulose Acetate (DS: | Film casting | 0.12 | 100 |
| 18 | 2.5) + 25% Triacetin] + 10% Talc + | | | |
| | 5% CaCO₃ + 0.025 phr Luperox ® | | | |
| | 101 | | | |
| Example | 70% [78% Cellulose Acetate (DS: | Compression | 0.4 | 91.4 |
| 19 | 2.5) + 22% Triacetin] + 5% CA-g- | moulding | | |
| | MA (with 8% Talc)] + 20% Talc + | | | |
| | 5% CaCO₃ + 0.075 phr Luperox ® | | | |
| | 101 | | | |
| Example | 65% [78% Cellulose Acetate (DS: | Compression | 0.4 | 95.1 |
| 20 | 2.5) + 22% Triacetin] + 5% CA-g- | moulding | | |
| | MA (with 8% Talc) + 25% Talc + | | | |
| | 5% Alkyl ketene dimer (AKD) + | | | |
| | 0.075 phr Luperox ® 101 | | | |

DS: degree of substitution

### Examples 21-25—Marine Biodegradation

Examples 21-25 demonstrate that the plasticized cellulose acetate compositions are marine biodegradable.

In Example 21, the plasticized cellulose acetate composition was obtained with the mixing and extrusion procedures analogous those of Example 1. The sample composition was given in Table 21. The material obtained by extrusion was reduced to a powder by cryogrinding. The powder was tested in accordance with ASTM D7991—Standard Test Method for Determining Aerobic Biodegradation of Plastics Buried in Sandy Marine Sediment under Controlled Laboratory Conditions.

In Example 22, the plasticized cellulose acetate composition was obtained with the mixing and extrusion procedures analogous those of Example 1. The powder obtained by cryogrinding was tested for aerobic biodegradation in a simulated marine environment in accordance with ASTM D7991.

In Example 23, the plasticized cellulose acetate composition was obtained in the same manner as in Example 2. The filler was microcrystalline cellulose. The plasticizer content was 25%. The additive was 0.025 phr organic peroxide (Luperox® 101 in this example). The powder obtained by cryogrinding was tested for aerobic biodegradation in a simulated marine environment in accordance with ASTM D7991.

In Example 24, the plasticized cellulose acetate composition was obtained in the same manner as in Example 23, except that the filler was hot-water-washed distiller's dried grains with solubles in lieu of microcrystalline cellulose. The powder obtained by cryogrinding was tested for aerobic biodegradation in a simulated marine environment in accordance with ASTM D7991.

In Example 25, the plasticized cellulose acetate composition was obtained in the same manner as in Example 1. The filler was talc and the additive was 0.025 phr organic peroxide (Luperox© 101). The powder obtained by cryogrinding was tested for aerobic biodegradation in a simulated marine environment in accordance with ASTM D7991.

The percentage of biodegradation is calculated as the ratio between the evolved CO2 and theoretical CO2. The degrees of biodegradation of Examples 21-25 tested at 25° C. after 379 days are shown in Table 21, with that of pure cellulose as a reference material.

TABLE 21
Aerobic biodegradation in marine environment

| | | % Biodegra- |
|---|---|---|
| | | dation after |
| Example # | Composition | 379 days |
| Reference | Cellulose | 95.4 |
| Example 21 | 75% Cellulose Acetate (DS: 2.5) + 25% | 77.8 |
| | Triethyl Citrate | |
| Example 22 | 75% Cellulose Acetate (DS: 2.5) + 25% | 80.4 |
| | Triacetin | |
| Example 23 | 80% [75% Cellulose Acetate (DS: 2.5) + | 81.4 |
| | 25% Triacetin] + 20% Microcrystalline | |
| | Cellulose + 0.025 phr Luperox ® 101 | |
| Example 24 | 80% [75% Cellulose Acetate (DS: 2.5) + | 91.7 |
| | 25% Triacetin] + 20% DDGS (Hot water | |
| | washed) + 0.025 phr Luperox ® 101 | |
| Example 25 | 80% [75% Cellulose Acetate (DS: 2.5) + | 95.8 |
| | 25% Triacetin] + 20% Talc + 0.025 phr | |
| | Luperox ® 101 | |

DS: degree of substitution;
DDGS: distiller's dried grains with solubles

### Examples 26-30—Moulded Articles

Examples 26-30 demonstrate that cellulose acetate compositions can be processed into plastic articles using common manufacturing processes such as injection moulding and thermoforming.

### Example 26—Injection Moulded Cutlery

The cellulose acetate composition was obtained in a manner analogous to Example 4. The formulation is: 69% [70% Cellulose Acetate (DS: 2.5)+30% Triethyl Citrate]+20% Talc+5% CaCO₃+6% Starch+0.05 phr Luperox® 101.

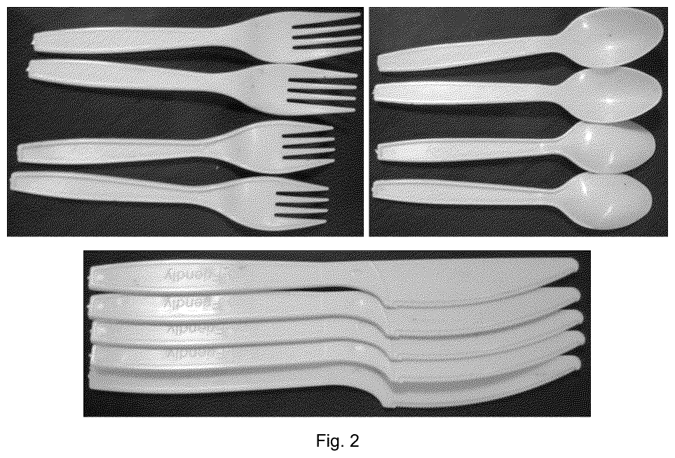

The composition was injection moulded into disposable cutlery items (i.e., forks, spoons, knives) as shown in FIG. 2.

### Example 27—Injection Moulded Nespresso® Compatible Coffee Capsules

The cellulose acetate composition was obtained in a manner analogous to Example 15. The formulation is: 72% [78% Cellulose Acetate (DS: 2.5)+22% Triacetin]+3% CA-g-MA (with 8% talc)+25% Talc+0.075 phr Luperox® 101.

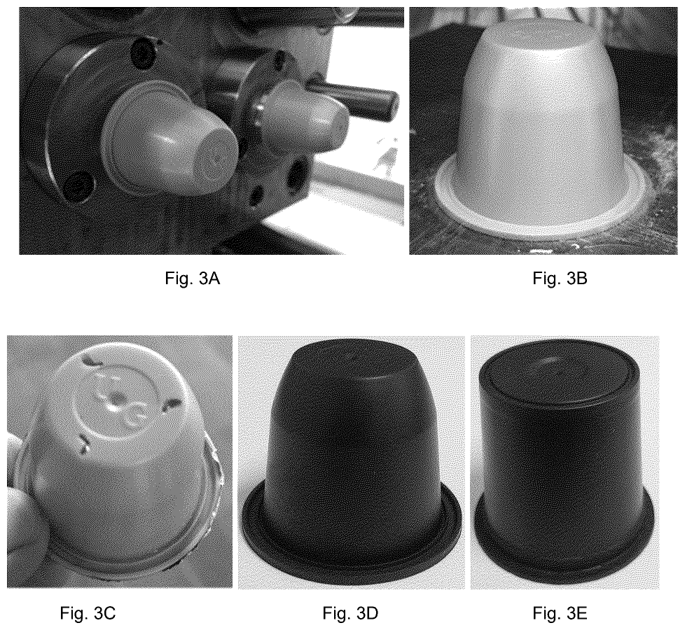

The composition was injection moulded into Nespresso compatible coffee capsules using ARBURG™ AllRounder 370 injection moulding machine, as shown in FIGS. 3A and 3B. The unique mould design produces capsules with a wall thickness of 0.4 mm, lower than the typical 0.6 mm thickness of commercial products. This can provide material and cost savings. Capsules of 0.6 mm in thickness were also produced for comparison.

The Nespresso® compatible coffee capsules gave satisfactory performance when used in an electric coffeemaker. They were punctured properly by the needle assembly of the coffeemaker. The capsules did not shutter and the punctured piece did not break loose, as shown in FIG. 3C.

### Example 28—Injection Moulded Nespresso® Compatible Coffee Capsules

The cellulose acetate composition was obtained in a manner analogous to Example 15. The formulation is: 72% {77% [80% Cellulose Acetate (DS: 2.5)+20% Cellulose Acetate (DS: 2.25)]+23% Triacetin}+5% CA-g-MA [DS: 2.5 & 2.25 (1:1 ratio) with 15% Silane-treated Talc]+10% Talc+10% Sub-micron Wood Biocarbon+3% Graphite+0.075 phr Luperox® 101.

The composition was injection moulded into Nespresso® compatible coffee capsules using ARBURG™ AllRounder 370 injection moulding machine, as shown in FIG. 3D.

### Example 29—Injection Moulded K-Cup® Compatible Coffee Capsules

The cellulose acetate composition was obtained in a manner analogous to Example 7. The formulation is: 77% {75% [80% Cellulose Acetate (DS: 2.5)+20% Cellulose Acetate (DS: 2.25)]+25% Triacetin}+15% micron-size Wood Biocarbon+8% Talc+0.075 phr Luperox® 101.

The composition was injection moulded into K-cup® compatible coffee capsules using ARBURG™ AllRounder 370 injection moulding machine, as shown in FIG. 3E.

### Example 30—Thermoformed Nespresso® Compatible Coffee Capsules

The cellulose acetate composition was obtained in a manner analogous to Example 3, with the following formulation: 77% [80% Cellulose Acetate (DS: 2.5)+20% Triacetin]+18% Talc+5% CaCO₃+0.075 phr Luperox® 101+0.5 phr Joncryl.

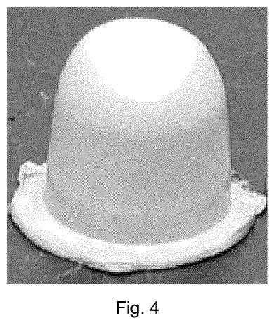

The pellets obtained by extrusion were compression moulded using Carver™ hot press into sheets at 240° C. The sheets were thermoformed into Nespresso® compatible coffee capsules (FIG. 4).

### Examples 31 and 32—Barrier Properties

Examples 31 and 32 demonstrate that the articles moulded from cellulose acetate compositions can have high oxygen barrier properties.

In Example 31, the Nespresso® compatible coffee capsules as obtained in Example 27 were sealed onto flat copper plate and assessed for both oxygen transmission rate (OTR) and water vapor transmission rate (WVTR). Fresh article was used in each OTR or WVTR test. The OTR was tested at 0% relative humidity (RH) and 23° C. and converted to permeation rate by accounting for the wall thickness. The WVTR was tested at 90% RH and 37.8° C. and also converted to permeation rate. Coffee capsules with two different thicknesses (0.6 and 0.4 mm) were moulded and tested.

In Example 32, the OTR and WVTR of the Nespresso® compatible coffee capsules obtained in Example 28 were assessed in the same manner as in Example 31.

The barrier properties measured in Examples 31 and 32 are shown in Table 22. The Nespresso® compatible coffee capsules moulded from cellulose acetate compositions of the present disclosure showed ultra-high oxygen barrier. The barrier properties were comparable to or exceed the performances of commercial products. They also had comparable water vapor barrier to commercial biodegradable products.

TABLE 22
Barrier properties of coffee capsules produced from the cellulose acetate compositions.

| | | | Oxygen | | Water vapor | |
|---|---|---|---|---|---|---|
| | | | transmission | Oxygen | transmission | Water vapor |
| | | Wall | rate | permeation rate | rate | permeation rate |
| Example | | thickness | (cc/pkg-day) | (cc · mil/pkg-day) | (g/pkg-day) | (g · mil/pkg-day) |
| # | Article | (mm) | (23° C., 0% RH) | (23° C., 0% RH) | (37.8° C., 90% RH) | (37.8° C., 90% RH) |
| Example 31 | Nespresso ® | 0.6 | 0.0207 | 0.4899 | 0.0665 | 1.5701 |
| | compatible | 0.4 | 0.0282 | 0.4440 | 0.1035 | 1.6296 |
| | coffee | | | | | |
| | capsules | | | | | |
| | (Example 27) | | | | | |
| Example 32 | Nespresso ® | 0.4 | 0.0141 ± 0.0008 | 0.2225 ± 0.0133 | 0.1247 ± 0.0005 | 1.964 ± 0.007 |
| | compatible | | | | | |
| | coffee | | | | | |
| | capsules | | | | | |
| | (Example 28) | | | | | |

As shown in Examples 1-4, the cellulose acetate compositions prepared without the addition of organic peroxide showed very low melt flow and were very difficult to be melt processed. Once fillers were added, the compositions could not be moulded even by heating and pressurization. The compositions did not produce continuous strands when being extruded.

Examples 1 to 32 demonstrate that with the method disclosed in the present disclosure, cellulose acetate compositions with high filler contents can be readily processed and injection moulded into articles. The compositions showed good mechanical properties, high barrier properties, and are biodegradable.

### REFERENCES

(1) Phuong, V. T.; Verstichel, S.; Cinelli, P.; Anguillesi, I.; Coltelli, M. B.; Lazzeri, A. Cellulose Acetate Blends—Effect of Plasticizers on Properties and Biodegradability. Journal of Renewable Materials 2014, 2 (1), 35-41. https://doi.org/10.7569/JRM.2013.634136.
(2) Wang, B.; Chen, J.; Peng, H.; Gai, J.; Kang, J.; Cao, Y. Investigation on Changes in the Miscibility, Morphology, Rheology and Mechanical Behavior of Melt Processed Cellulose Acetate through Adding Polyethylene Glycol as a Plasticizer. Journal of Macromolecular Science, Part B: Physics 2016, 55 (9), 894-907. https://doi.org/10.1080/00222348.2016.1217185.
(3) Meier, M. M.; Kanis, L. A.; de Lima, J. C.; Pires, A. T. N.; Soldi, V. Poly(caprolactone triol) as Plasticizer Agent for Cellulose Acetate Films: Influence of the Preparation Procedure and Plasticizer Content on the Physico-Chemical Properties. Polymers for Advanced Technologies 2004, 15 (10), 593-600. https://doi.org/10.1002/pat.517.
(4) Rama Rao, P.; Diwan, P. V. Permeability Studies of Cellulose Acetate Free Films for Transdermal Use: Influence of Plasticizers. Pharmaceutica Acta Helvetiae 1997, 72 (1), 47-51. https://doi.org/10.1016/S0031-6865(96)00060-X.
(5) Lee, S. H.; Shiraishi, N. Plasticization of Cellulose Diacetate by Reaction with Maleic Anhydride, Glycerol, and Citrate Esters during Melt Processing. Journal of Applied Polymer Science 2001, 81 (1), 243-250. https://doi.org/10.1002/app.1435.
(6) Quintana, R.; Persenaire, O.; Lemmouchi, Y.; Sampson, J.; Martin, S.; Bonnaud, L.; Dubois, P. Enhancement of Cellulose Acetate Degradation under Accelerated Weathering by Plasticization with Eco-Friendly Plasticizers. Polymer Degradation and Stability 2013, 98 (9), 1556-1562. https://doi.org/10.1016/j.polymdegradstab.2013.06.032.
(7) Michael-Sapia, E. K.; Rodig, M. J.; Donelson, M. E.; Cable, K. M.; De wit, J. S.; Izallalen, M.; Clendennen, S. K.; An, H.; Ghosh, K. Biodegradable Compositions and Articles Made from Cellulose Acetate. International Publication Number: WO 2021/150540 A1, 2021.
(8) Mohanty, A. K.; Drzal, L. T.; Park, H.; Misra, M.; Wibowo, A. C. Compositions of Cellulose Esters and Layered Silicates and Process for the Preparation Thereof. United State Patent Application US 2006/0058425A1, 2006.
(9) Buchanan, C. M.; Gardner, R. M.; Komarek, R. J. Aerobic Biodegradation of Cellulose Acetate. Journal of Applied Polymer Science 1993, 47 (10), 1709-1719. https://doi.org/10.1002/app.1993.070471001.
(10) Reese, E. T. Biological Degradation of Cellulose Derivatives. Industrial & Engineering Chemistry 1957, 49 (1), 89-93. https://doi.org/10.1021/IE50565A033
(11) Puls, J.; Wilson, S. A.; Hölter, D. Degradation of Cellulose Acetate-Based Materials: A Review. Journal of Polymers and the Environment 2011, 19 (1), 152-165. https://doi.org/10.1007/s10924-010-0258-0.
(12) Yadav, N.; Hakkarainen, M. Degradable or Not? Cellulose Acetate as a Model for Complicated Interplay between Structure, Environment and Degradation. Chemosphere 2021, 265, 128731-128740. https://doi.org/10.1002/mame.202100951
(13) Itoh, M.; Kiyose, A.; Hirao, K. Biodegradable Cellulose Ester Composition and Article Produced from the Same, European Patent Application 0 597 478 A1, 1993.
(14) Wilson, S. A.; Steach, J. K.; Fauver, J. S. Cellulose Esters Having Mixed-phase Titanium Dioxide Particles for Improved Degradation, United States Patent Application US 2012/0325233 A1, 2012.
(15) Ga, K.; Suzuki, M. Cellulose Acetate Composition and Molded Article. United States Patent Application US 2021/0363331 A1, 2021.
(16) Machell, J. S.; Sand, I. D. Method of Manufacture of Cellulose Ester Film. U.S. Pat. No. 5,219,510, 1993.
(17) Herniou-Julien, C.; Mendieta, J. R.; Gutiérrez, T. J. Characterization of Biodegradable/Non-Compostable Films Made from Cellulose Acetate/Corn Starch Blends Processed under Reactive Extrusion Conditions. Food Hydrocolloids 2019, 89, 67-79. https://doi.org/10.1016/j.foodhyd.2018.10.024.
(18) Braganga, F. C.; Rosa, D. S. Thermal, Mechanical and Morphological Analysis of Poly(s-caprolactone), Cellulose Acetate and Their Blends. Polymers for Advanced Technologies 2003, 14 (10), 669-675. https://doi.org/10.1002/pat.381.
(19) Quintana, R.; Persenaire, O.; Bonnaud, L.; Dubois, P. Recent Advances in (Reactive) Melt Processing of Cellulose Acetate and Related Biodegradable Bio-Compositions. Polymer Chemistry 2012, 3 (3), 591-595. https://doi.org/10.1039/c1py00421b.
(20) Wu, C. S. Characterization of Cellulose Acetate-Reinforced Aliphatic-Aromatic Copolyester Composites. Carbohydrate Polymers 2012, 87 (2), 1249-1256. https://doi.org/10.1016/j.carbpol.2011.09.009.
(21) Aluigi, A.; Vineis, C.; Ceria, A.; Tonin, C. Composite Biomaterials from Fibre Wastes: Characterization of Wool-Cellulose Acetate Blends. Composites Part A: Applied Science and Manufacturing 2008, 39 (1), 126-132. https://doi.org/10.1016/j.compositesa.2007.08.022.
(22) Chen, C.; Wang, L.; Huang, Y. Electrospun Phase Change Fibers Based on Polyethylene Glycol/Cellulose Acetate Blends. Applied Energy 2011, 88 (9), 3133-3139. https://doi.org/10.1016/j.apenergy.2011.02.026.
(23) De Moraes, A. C. M.; Andrade, P. F.; De Faria, A. F.; Simões, M. B.; Salomso, F. C. C. S.; Barros, E. B.; Gongalves, M. D. C.; Alves, O. L. Fabrication of Transparent and Ultraviolet Shielding Composite Films Based on Graphene Oxide and Cellulose Acetate. Carbohydrate Polymers 2015, 123, 217-227. https://doi.org/10.1016/j.carbpol.2015.01.034.
(24) Jeon, G. W.; An, J. E.; Jeong, Y. G. High Performance Cellulose Acetate Propionate Composites Reinforced with Exfoliated Graphene. Composites Part B: Engineering 2012, 43 (8), 3412-3418. https://doi.org/10.1016/j.compositesb.2012.01.023.
(25) Park, H. M.; Misra, M.; Drzal, L. T.; Mohanty, A. K. “Green” Nanocomposites from Cellulose Acetate Bioplastic and Clay: Effect of Eco-Friendly Triethyl Citrate Plasticizer. Biomacromolecules 2004, 5 (6), 2281-2288. https://doi.org/10.1021/bm049690f.
(26) Hassan-Nejad, M.; Ganster, J.; Bohn, A.; Pinnow, M.; Volkert, B. Bio-Based Nanocomposites of Cellulose Acetate and Nano-Clay with Superior Mechanical Properties. Macromolecular Symposia 2009, 280 (1), 123-129. https://doi.org/10.1002/masy.200950614.
(27) Marrez, D. A.; Abdelhamid, A. E.; Darwesh, O. M. Eco-Friendly Cellulose Acetate Green Synthesized Silver Nano-Composite as Antibacterial Packaging System for Food Safety. Food Packaging and Shelf Life 2019, 20, 100302. https://doi.org/10.1016/j.fpsl.2019.100302.
(28) Gao, Y.; Wang, X.; Li, X.; Dai, H. An Antibacterial Composite Film Based on Cellulose Acetate/TiO₂ Nanoparticles. New Journal of Chemistry 2020, 44 (47), 20751-20758. https://doi.org/10.1039/d0nj04374e.
(29) Nakanishi, M. Cellulose Acetate Based Resin Foam with Biodegradability and Also Excellent Mechanical Property and Heat Moldability, and Cellulose Acetate Based Resin Foam Molded Article with Biodegradability and Also Excellent Mechanical Property and Dimensional stability. Japanese Patent Application JP2001200084A, 2000.
(30) Buchanan, C. M.; Gardner, R. M.; Wood, M. D.; White, A. W.; Gedon, S. C.; Barlow, F. D. Alephatic-Aromatic Copolyesters and Cellulose Ester/Polymer Blends. U.S. Pat. No. 5,292,783, 1994.
(31) Buchanan, C. M.; Gardner, R. M.; Wood, M. D.; Gedon, S. C.; Barlow, F. D. Aliphatic-Aromatic Copolymers and Cellulose Ester/Polymer Blends. U.S. Pat. No. 5,599,858, 1997.
(32) Law, P. W.; Longdon, T.; Sillence, K.; Wetters, D. J.; Perez, D. A. Bio-Resins. European Patent Application EP 2 500 378 A1, 2012.
(33) Longdon, T.: Law, P. W.: Sillence, K.: Wetters, D. J.: Perez, D. A. Bio-resins, U.S. Pat. No. 9,062,186 B2, 2015.
(34) Liu, H.; Gao, Z.; Hu, X.; Wang, Z.; Su, T.; Yang, L.; Yan, S. Blending Modification of PHBV/PCL and Its Biodegradation by Pseudomonas mendocina. Journal of Polymers and the Environment 2017, 25 (2), 156-164. https://doi.org/10.1007/s10924-016-0795-2.
(35) Laura Di Lorenzo, M. Poly(I-Lactic Acid)/Poly(Butylene Succinate) Biobased Biodegradable Blends. Polymer Reviews 2020. https://doi.org/10.1080/15583724.2020.1850475.
(36) Mohanty, A. K.; Misra, M.; Wu, F. Biodegradable Nanostructured Composites. U.S. Pat. No. 11,279,823 B2, 2022.
(37) Wu, F., Misra, M., Mohanty, A. K., Novel tunable super-tough materials from biodegradable polymer blends: Nano-structuring through reactive extrusion, RSC Advances 2019, 9, 2836. https://doi.org/10.1039/c8ra09596e.

Although various embodiments of the disclosure have been described and illustrated, it will be apparent to those skilled in the art in light of the present description that numerous modifications and variations can be made. The scope of the invention is defined more particularly in the appended claims.

What is claimed is:

1. A cellulose acetate composition comprising at least one cellulose acetate, at least one plasticizer, and at least one additive, wherein the at least one additive is an organic peroxide.

2. The composition of claim 1 further comprising at least one filler, wherein the at least one filler is in the amount up to 40 wt %, and wherein the at least one filler includes biocarbon derived from biomass or waste resources, a mineral filler, and an organic filler, and wherein:
the mineral filler includes one or more of talc, calcium carbonate, wollastonite, calcium sulfate, mica, magnesium oxysulfate, silica, and kaolin, and
the organic filler includes one or more of starch, cellulose, and microcrystalline cellulose.

3. The composition of claim 1, wherein the composition is characterized by having a melt flow index greater than 6 (g/10 min) (210° C., 2.16 kg).

4. The composition of claim 1, wherein the composition further comprises an anhydride-grafted cellulose acetate compatibilizer.

5. The composition of claim 1, wherein the composition has a heat deflection temperature greater than 85° C.

6. The composition of claim 1, wherein moulded sheets of the composition with a thickness of up to 0.4 mm reach a degree of disintegration of at least 90% within twelve weeks (84 days) under thermophilic aerobic composting conditions.

7. The composition of claim 1, wherein a powder form of the composition reaches at least 90% biodegradation within one year in sandy marine environment.

8. An article of manufacture comprising the composition of claim 1.

9. The article of claim 8, wherein the article is a melt-processed article or a moulded article.

10. A method for preparing the cellulose acetate composition of claim 1, the method comprising:
(a) mixing at least one cellulose acetate with at least one plasticizer to produce a pre-mixture; and
(b) adding at least one additive to the pre-mixture, wherein said at least one additive is an organic peroxide, thereby obtaining the thermoplastic cellulose acetate composition.

11. The method of claim 10, wherein said at least one additive is present in the amount from 0.03 to 1 phr.

12. The method of claim 11, wherein the at least one additive is an organic peroxide, and wherein the organic peroxide is mixed with at least one filler prior to being added to the pre-mixture of cellulose acetate and plasticizer, wherein the at least one filler facilitates the dispersion of the organic peroxide, and the organic peroxide facilitates the adhesion between the at least one filler and cellulose acetate, and wherein the at least one filler includes biocarbon derived from biomass or waste resources, a mineral filler, an organic filler, or a combination thereof.

13. The method of claim 10, wherein the cellulose acetate has a degree of substitution from 1.2 to 2.9.

14. The method of claim 10, wherein the plasticizer is present in an amount from 5 to 50% with respect to the weight of cellulose acetate and plasticizer.

15. The method of claim 10, wherein the organic peroxide is combined with a hybrid of different types of plasticizers to adjust the melt flow and mechanical properties of the thermoplastic cellulose acetate composition, and wherein the hybrid of different plasticizers includes biodegradable plasticizers.

16. The method of claim 12, wherein the method further comprises the step of adding an anhydride-grafted cellulose acetate to the thermoplastic cellulose acetate composition.

17. A method of increasing the melt flow index of a cellulose acetate composition, the method comprising adding an additive to a mixture of cellulose acetate and a plasticizer, wherein the additive is an organic peroxide.

18. The method of increasing the melt flow of a cellulose acetate composition of claim 17, wherein the method further comprising mixing the additive with at least one filler prior to adding the additive to the mixture of cellulose acetate and plasticizer, wherein the at least one filler includes biocarbon derived from biomass or waste resources, a mineral filler, an organic filler, or a combination thereof.

19. A method of preparing an anhydride-grafted cellulose acetate compatibilizer by single-step reactive extrusion, the method comprising mixing at least one cellulose acetate, at least one plasticizer, at least one additive, and at least one filler,
wherein the at least one plasticizer is present in the amount from 10 to 50 wt %,
wherein the at least one additive is an organic peroxide, an acid anhydride, or a combination of the organic peroxide and the acid anhydride, and
wherein the at least one filler includes biocarbon derived from biomass or waste resources, a mineral filler, an organic filler, or a combination thereof.

20. The method of claim 19, wherein the organic peroxide is from 0.03 to 1 phr.
